(19) United States
(12) Patent Application Publication
(10) Pub. No.: US 2019/0287058 A1
(43) Pub. Date: Sep. 19, 2019

(54) DELIVERY MANAGEMENT SYSTEM, KEY INFORMATION MANAGEMENT DEVICE, DELIVERY MANAGEMENT DEVICE, DELIVERY MANAGEMENT METHOD, AND NON-TRANSITORY RECORDING MEDIUM HAVING PROGRAM STORED THEREIN

(71) Applicant: TOYOTA JIDOSHA KABUSHIKI KAISHA, Toyota-shi (JP)

(72) Inventors: Ryuichi SUZUKI, Nagakute-shi (JP); Yuki ITO, Iwakura-shi (JP); Hiroyasu SHIOKAWA, Nagoya-shi (JP); Yasumasa KOBAYASHI, Nagoya-shi (JP); Naoki YAMAMURO, Nagoya-shi (JP); Makoto AKAHANE, Nagoya-shi (JP)

(73) Assignee: TOYOTA JIDOSHA KABUSHIKI KAISHA, Toyota-shi (JP)

(21) Appl. No.: 16/299,286

(22) Filed: Mar. 12, 2019

(30) Foreign Application Priority Data
Mar. 14, 2018 (JP) 2018-046742

(51) Int. Cl. G06Q 10/08; B60R 25/24

(52) U.S. Cl. CPC G06Q 10/0832; G06Q 10/08355; B60R 25/241

(57) ABSTRACT

A delivery management system includes a server configured to: receive a delivery request of a purchased product which is purchased at a store in a delivery coverage area including a plurality of stores, information about the purchased product, and information about a purchase user who purchases the purchased product; store key information of a vehicle associated with the purchase user, the vehicle being configured to be locked and unlocked upon receipt of the key information transmitted from a terminal; acquire positional information of the vehicle; and transmit, to a terminal of a delivery user, the delivery request of the purchased product, the information about the purchased product, the key information of the vehicle, and the positional information of the vehicle, wherein the delivery request of the purchased product is a request of delivering the purchased product to the vehicle.

### INCORPORATION BY REFERENCE

The disclosure of Japanese Patent Application No. 2018-046742 filed on Mar. 14, 2018 including the specification, drawings and abstract is incorporated herein by reference in its entirety.

### BACKGROUND

### 1. Technical Field

The disclosure relates to a delivery management system, a key information management device, a delivery management device, a delivery management method and a non-transitory recording medium having a program stored therein.

### 2. Description of Related Art

In recent years, there has been developed a system in which a portable terminal such as a smartphone is usable as a key for a vehicle. In such a system, when key information associated with a vehicle is transmitted to the vehicle from a portable terminal, the vehicle is locked and unlocked, so that access to the inside of the vehicle is allowed (e.g., International Publication No. 2015/149910).

Further, there has been developed a system in which, even when a recipient is absent, a delivery package is delivered such that mutual authentication is performed between a communicator provided in a vehicle of a delivery carrier and a package-receiving vehicle by use of authentication information registered in advance, and the delivery package is stored in a trunk (for example, Japanese Unexamined Patent Application Publication No. 2006-206225 (JP 2006-206225 A)).

### SUMMARY

In the meantime, in a case where a user purchases a product in a predetermined area such as a shopping mall or a shopping street that includes a plurality of stores, the user should carry the product while the user moves around, or the user should temporarily put the product in a baggage room such as a coin-operated locker. This is inconvenient in either case. For example, in a case where the user visits the predetermined area by a vehicle and parks the vehicle there to do shopping, it is conceivable that a purchased product is stored in the vehicle of the user. However, it is more likely to be troublesome for the user that the user should do this in the middle of shopping.

Further, a system in which a delivery package is stored in a trunk of a vehicle while a recipient is absent, like the system in the related art, assumes a case where delivery is performed in a relatively large area over a prefecture, a city, a town, and the like and a time required for the delivery is relatively long from about several days to several weeks. However, the system does not assume a case where delivery is performed within a relatively small range such as an area inside a shopping mall and the delivery requires a relatively short time from about several tens of minutes to several hours.

The disclosure provides a delivery management system, a key information management device, a delivery management device, a delivery management method and a non-transitory recording medium having a program stored therein, each of which can improve convenience of shopping in a predetermined area including a plurality of stores.

A first aspect of the present disclosure relates to a delivery management system including a server configured to: receive a delivery request of a purchased product which is purchased at a store in a delivery coverage area including a plurality of stores, information about the purchased product, and information about a purchase user who purchases the purchased product; store key information of a vehicle associated with the purchase user, the vehicle being configured to be locked and unlocked upon receipt of the key information transmitted from a terminal; acquire positional information of the vehicle; and transmit, to a terminal of a delivery user, the delivery request of the purchased product, the information about the purchased product, the key information of the vehicle, and the positional information of the vehicle, wherein the delivery request of the purchased product is a request of delivering the purchased product to the vehicle.

In the above aspect, the server may be configured to receive the delivery request of the purchased product, the information about the purchased product, and the information about the purchase user that are transmitted from a terminal of the purchase user.

In the above first aspect, the delivery management may further include a plurality of store terminals each of which is provided in each of the plurality of the stores respectively, wherein each of the plurality of the store terminals may be configured to transmit the delivery request of the purchased product, the information about the purchased product, and the information about the purchase user.

Examples of the delivery coverage area including the stores are an area inside the site of a shopping center, a management area of a shopping street, and the like. The information about the purchased product includes an identification number, a type, a feature, and the like of the purchased product, for example. Examples of the information about the purchase user are identification information of the purchase user, identification information of a terminal of the purchase user, and the like. Examples of the positional information of the vehicle are information indicative of latitude and longitude, information indicative of an address, information indicative of a parking position, and the like.

When the key information and the positional information of the vehicle are transmitted to the terminal of the delivery user, delivery of the purchased product to the vehicle inside the delivery coverage area can be achieved. Accordingly, the purchase user associated with the vehicle can go around stores in the delivery coverage area without carrying the purchased product, and the purchased product is put in the vehicle before the purchase user comes back to the vehicle, so that convenience of shopping in the delivery coverage area improves. Further, the delivery user can know the positional information of the vehicle, so that the delivery user can surely reach the vehicle as a delivery destination.

In the above first aspect, the server may be configured to: determine whether or not the vehicle is parked in a parking space inside the delivery coverage area; and transmit the key information of the vehicle and the positional information of the vehicle to the terminal of the delivery user, when the vehicle is parked in the parking space inside the delivery coverage area. With the above aspect, delivery of the purchased product to the vehicle can be limited to the delivery coverage area.

A second aspect of the present disclosure relates to a key information management device including a processor configured to: receive a delivery request of a purchased product which is purchased at a store in a delivery coverage area including a plurality of stores, and information about a purchase user who purchases the purchased product; store key information of a vehicle associated with the purchase user, the vehicle being configured to be locked and unlocked upon receipt of the key information transmitted from a terminal; acquire positional information of the vehicle; and transmit the key information of the vehicle and the positional information of the vehicle to a terminal of a delivery user who receives the delivery request of the purchased product, wherein the delivery request of the purchased product is a request of delivering the purchased product to the vehicle.

In the above aspect, the processor may be configured to: determine whether or not the vehicle is parked in a parking space inside the delivery coverage area; and transmit the key information of the vehicle and the positional information of the vehicle to the terminal of the delivery user, when the vehicle is parked in the parking space inside the delivery coverage area.

A third aspect of the present disclosure relates to a delivery management device including a processor configured to: receive a delivery request of a purchased product which is purchased at a store in a delivery coverage area including a plurality of stores, information about the purchased product, and information about a purchase user who purchases the purchased product; receive key information of a vehicle associated with the purchase user and positional information of the vehicle, the vehicle being configured to be locked and unlocked upon receipt of the key information transmitted from a terminal; and transmit, to a terminal of a delivery user, the delivery request of the purchased product, the information about the purchased product, the key information of the vehicle, and the positional information of the vehicle, wherein the delivery request of the purchased product is a request of delivering the purchased product to the vehicle.

A fourth aspect of the present disclosure relates to a delivery management method including: causing a computer to receive a delivery request of a purchased product which is purchased at a store in a delivery coverage area including a plurality of stores, information about the purchased product, and information about a purchase user who purchases the purchased product; causing the computer to store key information of a vehicle associated with the purchase user, the vehicle being configured to be locked and unlocked upon receipt of the key information transmitted from a terminal; causing the computer to acquire positional information of the vehicle; and causing the computer to transmit, to a terminal of a delivery user, the delivery request of the purchased product, the information about the purchased product, the key information of the vehicle, and the positional information of the vehicle, wherein the delivery request of the purchased product is a request of delivering the purchased product to the vehicle.

A fifth aspect of the present disclosure relates to a non-transitory recording medium having a program stored therein, the program causing a computer to perform a control process, the control process including: receiving a delivery request of a purchased product which is purchased at a store in a delivery coverage area including a plurality of stores, information about the purchased product, and information about a purchase user who purchases the purchased product; storing key information of a vehicle associated with the purchase user, the vehicle being configured to be locked and unlocked upon receipt of the key information transmitted from a terminal; acquiring positional information of the vehicle; and transmitting, to a terminal of a delivery user, the delivery request of the purchased product, the information about the purchased product, the key information of the vehicle, and the positional information of the vehicle, wherein the delivery request of the purchased product is a request of delivering the purchased product to the vehicle.

With the present disclosure, the convenience of shopping in a predetermined area including a plurality of stores can be improved.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view illustrating the outline of a key system according to a first embodiment;

FIG. 2 illustrates an example of a system configuration of the key system according to the first embodiment;

FIG. 3 is a view illustrating a process and a data flow at the time when a door of a vehicle is unlocked;

FIG. 4 is a view illustrating an example of a system configuration of a purchased product delivery system according to the first embodiment;

FIG. 5 is a view illustrating an example of a hardware configuration of a center server;

FIG. 6 is a view illustrating an example of a hardware configuration of the vehicle;

FIG. 7 is a view illustrating an example of functional configurations of a center server, a collection/delivery management server, the vehicle, a user terminal of a user of the vehicle, and a user terminal of a delivery user in the purchased product delivery system according to the first embodiment;

FIG. 8 illustrates an example of a setting screen, of the user terminal, for a delivery request of a purchased product to the vehicle;

FIG. 9 illustrates an example of a vehicle management information table;

FIG. 10 illustrates an example of a delivery management information table;

FIG. 11 illustrates an example of a flowchart of a request acceptance process of a request accepting portion of the center server according to the first embodiment;

FIG. 12 illustrates an example of a flowchart of an issue controlling process of an issue controlling portion of the center server according to the first embodiment;

FIG. 13 illustrates an example of a processing sequence in a concrete example of the first embodiment;

FIG. 14 is a view illustrating an example of a system configuration of a purchased product delivery system according to a second embodiment;

FIG. 15 is a view illustrating an example of functional configurations of a center server, a collection/delivery management server, a vehicle, a user terminal of a delivery user, a store server, and a POS terminal in the purchased product delivery system according to the second embodiment;

FIG. 16 illustrates an example of a purchase history information table; and

FIG. 17 illustrates an example of a flowchart of a request acceptance process of a request accepting portion of the store server according to the second embodiment; and

FIG. 18 illustrates an example of a processing sequence in a concrete example of the second embodiment.

### DETAILED DESCRIPTION OF EMBODIMENTS

The following describes embodiments of the disclosure with reference to the drawings. The configurations in the following embodiments are examples, and the disclosure is not limited to the configurations in the embodiments.

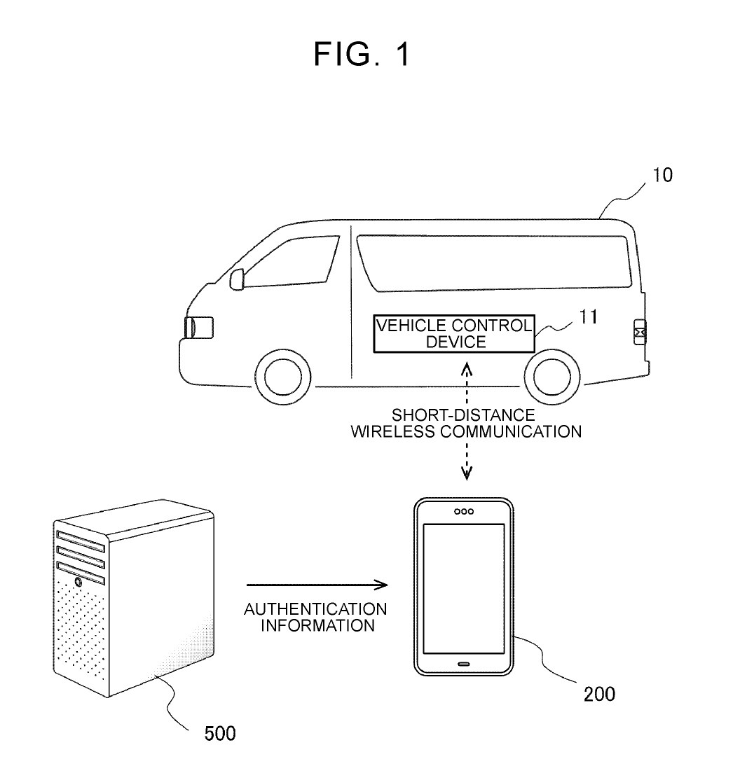

FIG. 1 is a view illustrating the outline of a key system according to a first embodiment. The key system according to the first embodiment includes a vehicle control device 11 provided in a vehicle 10, a user terminal 200, and a center server 500. The user terminal 200 and the center server 500 are connected to each other via a network such as the Internet that is a public communication network. Further, the user terminal 200 and the vehicle control device 11 are connected to each other via short-distance wireless communication.

The center server 500 is a device configured to manage authentication information associated with the vehicle 10. When the user terminal 200 receives authentication information transmitted from the center server 500, the user terminal 200 is usable as a key of the vehicle 10. When the user terminal 200 is used as the key of the vehicle 10, the user terminal 200 transmits the authentication information received from the center server 500 to the vehicle control device 11 provided in the vehicle 10 via short-distance wireless communication. The vehicle control device 11 performs authentication by use of the authentication information received from the user terminal 200. When the authentication is successful, the vehicle control device 11 can execute various controls on the vehicle 10. One of the controls executed by the vehicle control device 11 on the vehicle 10 is locking and unlocking of the door of the vehicle 10, and the like. The key system is an example of a “key system” of the present disclosure. The authentication information is an example of “key information” of the present disclosure. The center server 500 is an example of a “key information management device” of the present disclosure.

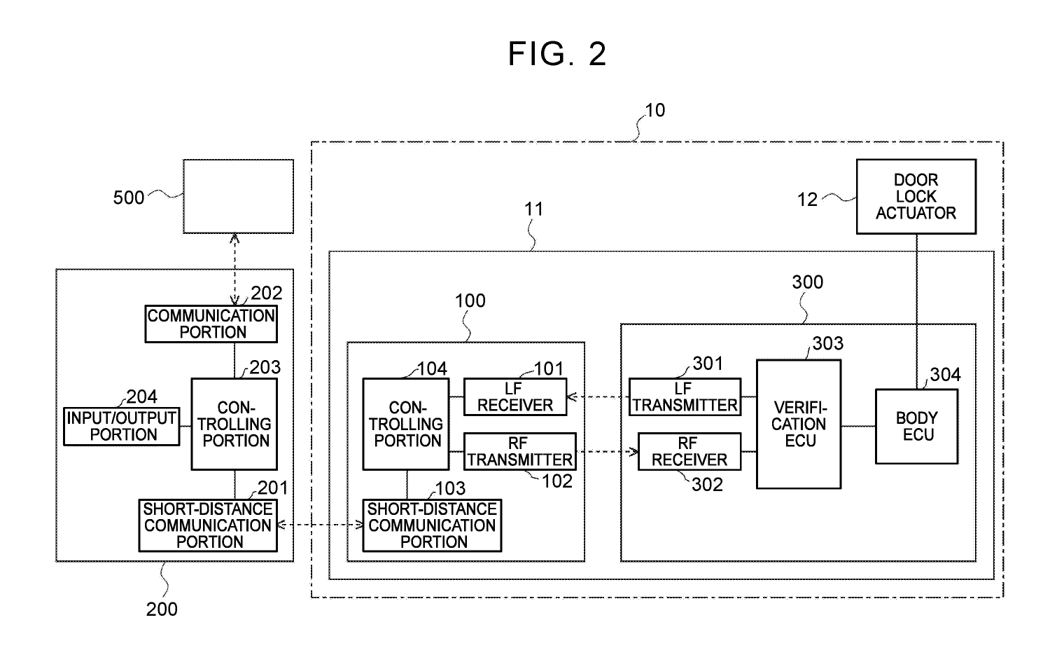

FIG. 2 illustrates an example of a system configuration of the key system according to the first embodiment. FIG. 2 is a block diagram diagrammatically illustrating an example of configurations of the user terminal 200 and the vehicle control device 11 illustrated in FIG. 1. The vehicle control device 11 includes a key unit 100 configured to communicate with the user terminal 200, and a control device 300 configured to execute various controls on the vehicle 10.

The control device 300 executes various controls by transmitting and receiving, to and from the key unit 100, a radio frequency (hereinafter referred to as RF) band radio wave and a low frequency (hereinafter referred to as LF) band radio wave in the vehicle 10. For example, the control device 300 controls a door lock actuator 12 of the vehicle 10 so as to execute a locking/unlocking control to lock and unlock the door of the vehicle 10.

The control device 300 includes an LF transmitter 301, an RF receiver 302, a verification ECU 303, and a body ECU (engine control unit) 304. The LF transmitter 301 is a device configured to transmit the LF band radio wave (e.g., 100 KHz to 300 KHz) so as to perform searching (polling) for the key unit 100. The RF receiver 302 is a device configured to receive the RF band radio wave (e.g., 100 MHz to 1 GHz) transmitted from the key unit 100.

The verification ECU 303 is a computer configured to control the body ECU 304 based on a command signal received from the key unit 100 via the RF band radio wave. The verification ECU 303 is a microcomputer, for example. The verification ECU 303 authenticates that the command signal transmitted from the key unit 100 is transmitted from a rightful device. More specifically, the verification ECU 303 determines whether or not a key ID included in the command signal corresponds with a key ID stored in advance in a storage portion included in the verification ECU 303.

When the verification ECU 303 succeeds in authentication of the key ID, the verification ECU 303 transmits a command corresponding to the command signal to the body ECU 304 via an in-vehicle network such as a controller area network (CAN). More specifically, when the command signal received from the key unit 100 is a locking signal, the verification ECU 303 transmits a locking command to lock the vehicle 10 to the body ECU 304. Further, when the command signal received from the key unit 100 is an unlocking signal, the verification ECU 303 transmits an unlocking command to unlock the vehicle 10 to the body ECU 304.

The body ECU 304 is a computer configured to perform a body control of the vehicle 10. The body ECU 304 is electrically connected to the door lock actuator 12 configured to lock and unlock the door of the vehicle 10. The body ECU 304 has a function to perform locking and unlocking of the vehicle 10 by controlling the door lock actuator 12 based on the locking command or the unlocking command received from the verification ECU 303.

Descriptions are now made of the key unit 100. The key unit 100 is a device placed at a predetermined position (for example, inside a glove compartment) in a vehicle cabin of the vehicle 10. The key unit 100 has a function to authenticate the user terminal 200 via short-distance wireless communication with the user terminal 200 and a function to transmit a command signal to the control device 300 by use of the RF band radio wave based on the authentication result. The key unit 100 is constituted by an LF receiver 101, an RF transmitter 102, a short-distance communication portion 103, and a controlling portion 104.

The LF receiver 101 is a device configured to receive a polling signal transmitted from the control device 300 via the LF band radio wave. The RF transmitter 102 is a device configured to transmit a command signal to the control device 300 via the RF band radio wave. The short-distance communication portion 103 is a device configured to communicate with the user terminal 200 outside the vehicle 10. The short-distance communication portion 103 performs communication in a short distance (to such a degree that communication can be performed between the inside of the vehicle cabin and the outside of the vehicle cabin) by use of a predetermined wireless communication standard. Note that examples of a telecommunications standard usable for the communication by the short-distance communication portion 103 include a Bluetooth (registered trademark) Low Energy protocol, a near field communication (NFC), an ultrawide band (UWB), WiFi (registered trademark), and the like.

The controlling portion 104 is a computer configured to perform a process of performing short-distance wireless communication with the user terminal 200, a process of authenticating the user terminal 200, a process of transmitting a command signal to the control device 300, and the like. The controlling portion 104 is constituted by a microcomputer, for example.

The controlling portion 104 has a function to control the LF receiver 101, the RF transmitter 102, and the short-distance communication portion 103. Further, the controlling portion 104 authenticates authentication information included in a control request transmitted from the user terminal 200 via short-distance wireless communication. More specifically, the controlling portion 104 determines whether or not authentication information transmitted from the user terminal 200 corresponds with authentication information stored in advance in a storage portion included in the controlling portion 104. When the authentication is successful, the controlling portion 104 transmits a command signal corresponding to the control request received from the user terminal 200 to the control device 300 via the RF transmitter 102. More specifically, when the control request received from the user terminal 200 is a locking request, the controlling portion 104 transmits a locking signal to the control device 300. Further, when the control request received from the user terminal 200 is an unlocking request, the controlling portion 104 transmits an unlocking signal to the control device 300.

At this time, the key unit 100 transmits a key ID to the control device 300 together with the command signal. The key ID may be stored in the key unit 100 in advance as a plain text or may be stored in an encrypted state where the key ID is encrypted by a cipher code inherent to the user terminal 200. When the key ID is stored in the encrypted state, the key ID thus encrypted may be decrypted by the authentication information transmitted from the user terminal 200, so that an original key ID may be obtained.

Descriptions are now made of the user terminal 200. The user terminal 200 is a small computer such as a smartphone, a mobile phone terminal, a tablet terminal, a personal information terminal, and a wearable computer (a smart watch and the like). The user terminal 200 is constituted by a short-distance communication portion 201, a communication portion 202, a controlling portion 203, and an input/output portion 204.

The short-distance communication portion 201 is a device configured to communicate with the key unit 100 of the vehicle control device 11 by the same telecommunications standard as the short-distance communication portion 103. The communication portion 202 is a device configured to connect the user terminal 200 to a network so as to communicate with the center server 500. The communication portion 202 can communicate with the center server 500 via a network by use of a mobile communication service such as 3G or LTE, for example. Note that, as will be described later, the communication portion 202 of the user terminal 200 also communicates, via a network, with a terminal management server configured to manage the user terminal.

The controlling portion 203 is a computer configured to manage a control of the user terminal 200. The controlling portion 203 is constituted by a microcomputer, for example. The controlling portion 203 performs a process of receiving authentication information transmitted from the center server 500, via the communication portion 202. Note that the authentication information received from the center server 500 is stored in a storage portion included in the controlling portion 203. Further, the controlling portion 203 performs a process of generating a control request corresponding to an input operation of a terminal user as a user who possesses the user terminal 200 and transmitting the control request to the key unit 100 via the short-distance communication portion 201 together with the authentication information stored in the storage portion.

The input/output portion 204 also functions as means that receives an input operation performed by the terminal user and provides information to the terminal user. More specifically, the input/output portion 204 is constituted by a touch panel display and its control means. Note that the input/output portion 204 may include a hardware switch or the like to be operated by the terminal user. Further, the input/output portion 204 may include a speaker that outputs sound or audio by being controlled by the controlling portion 203.

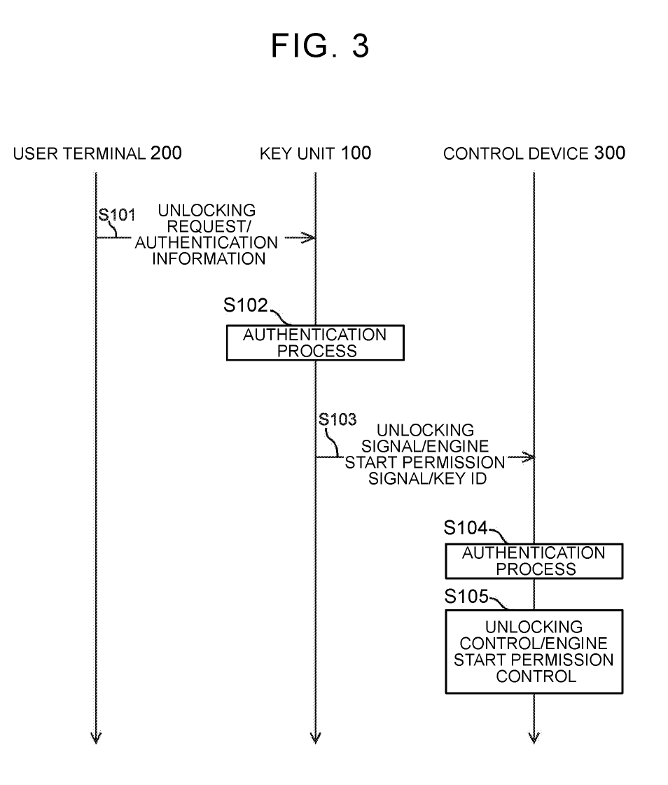

Here, the following describes a case where the door of the vehicle 10 is unlocked by the operation of the key system at the time when the user controls the vehicle 10 by use of the user terminal 200, as an example. FIG. 3 is a view illustrating a process and a data flow at the time when the door of the vehicle 10 is unlocked.

When the user performs, on the user terminal 200, an operation to unlock the door of the vehicle 10, the user terminal 200 transmits an unlocking request and authentication information to the key unit 100 of the vehicle control device 11 (S101). The key unit 100 performs an authentication process based on the authentication information received from the user terminal 200 (S102). When the authentication information is successfully authenticated, the key unit 100 transmits the key ID to the control device 300 together with an unlocking signal and an engine start permission signal (S103). Then, the control device 300 performs an authentication process based on the key ID received from the key unit 100 (S104). When the key ID is successfully authenticated, the control device 300 performs an unlocking control to unlock the door of the vehicle 10 (S105).

The first embodiment deals with a purchased product delivery system in which, in a case where a vehicle that employs the key system described above is parked in a parking space in a predetermined commercial area such as a shopping mall or a shopping street, for example, a product purchased by a user of the vehicle at a store in the commercial area is delivered to the vehicle.

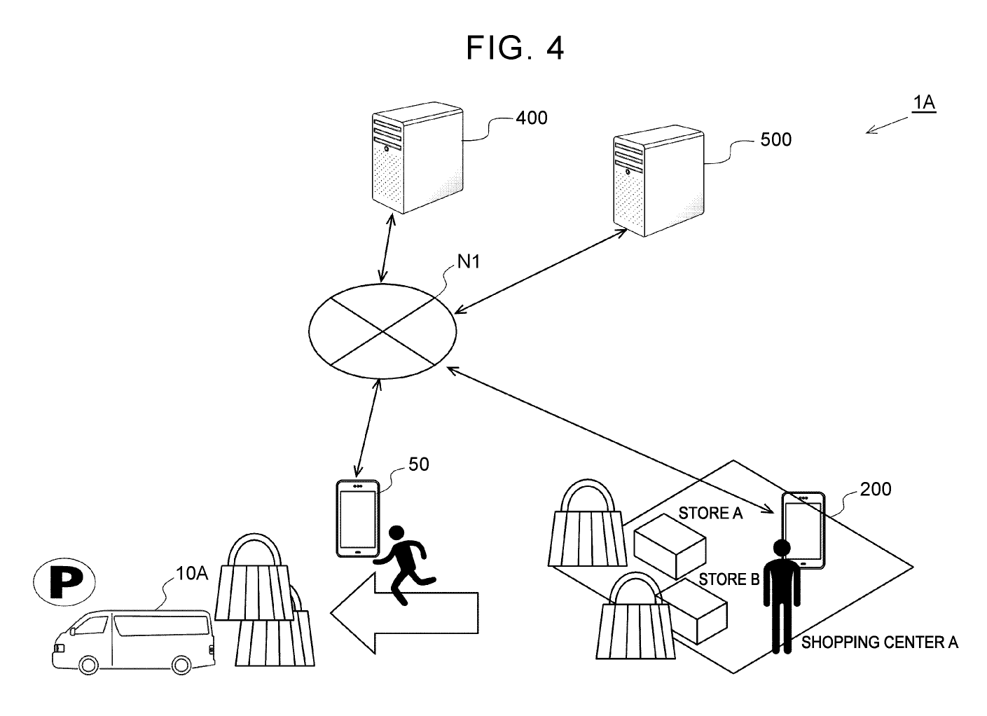

FIG. 4 is a view illustrating an example of a system configuration of a purchased product delivery system 1A according to the first embodiment. The purchased product delivery system 1A includes a vehicle 10A, a user terminal 200 of a user of the vehicle 10A, the center server 500, a collection/delivery management server 400, and a user terminal 50 of a delivery user. The center server 500 and the collection/delivery management server 400 are connected to a network N1, so that they can communicate with each other. The network N1 is the Internet, for example. The purchased product delivery system 1A is an example of a “delivery management system.”

The vehicle 10A is a vehicle that employs the above key system. The center server 500 is a server configured to manage authentication information and positional information of the vehicle 10A. The positional information of the vehicle 10A is transmitted from the vehicle 10A to the center server 500 at a predetermined cycle, for example. Further, the center server 500 is a server configured to provide, to the user of the vehicle 10A, a service of delivering a product purchased at a store to the vehicle 10A parked in a parking space of a shopping center A including a plurality of stores. The vehicle 10A is an example of “a vehicle that employs a key system in which locking and unlocking is performed upon receipt of key information transmitted from a terminal.” The user of the vehicle 10A is an example of a “purchase user.”

The collection/delivery management server 400 is a server of a parcels delivery company in charge of delivery of a purchased product at a store to the vehicle 10A in a management area of the shopping center A, for example. For example, a company that manages the collection/delivery management server 400 is different from a company that manages the center server 500. The user terminal 50 is a terminal possessed by a delivery carrier belonging to the company that manages the collection/delivery management server 400. Accordingly, the user terminal 50 is connected to the collection/delivery management server 400 via the network N1. On the other hand, the user terminal 50 does not communicate with the center server 500.

The user terminal 200 is a terminal of the user of the vehicle 10A, for example. The authentication information, the positional information, and the like of the vehicle 10A are managed by the center server 500. An application to receive the service provided by the center server 500 by use of the vehicle 10A is installed in the user terminal 200, for example, and the user terminal 200 can communicate with the center server 500 via the network N1 through execution of the application. One of services that the user of the vehicle 10A can receive through execution of the application is a delivery service of a purchased product at a store in the shopping center A to the vehicle 10A. The user terminal 200 is an example of a “terminal of a purchase user.”

For example, when the user of the vehicle 10A purchases a product A at a store A, a delivery request of delivering the product A to the vehicle 10A is transmitted from the user terminal 200 to the center server 500. Information about the purchased product, identification information of the vehicle 10A, and identification information of the user are also transmitted together with the delivery request, for example. The information about the purchased product includes identification information of the purchased product, identification information of a purchase store, a type of the purchased product, a feature of the purchased product, and so on. The identification information of the purchased product is a product number of the purchased product, and the like, for example. The information about the purchased product may be input by the user of the vehicle 10A directly into the user terminal 200 or may be acquired from a captured image obtained by capturing a purchase receipt or the like of the purchased product by a camera or the like of the user terminal 200, a bar code or a QR Code (registered trademark) shown on the receipt, or the like. Alternatively, the information about the product may be acquired from a POS terminal or the like of the store through an E-mail or the like transmitted via short-distance communication such as NFC or via the network N1. The information about the purchased product is an example of “information about a purchased product.” The identification information of the user is an example of “information about a purchase user.”

In the first embodiment, the center server 500 receives a delivery request of delivering the product A to the vehicle 10A from the user terminal 200 and transmits the delivery request to the collection/delivery management server 400. Delivery management information of the product A, vehicle specification information of the vehicle 10A, and the like are also transmitted to the collection/delivery management server 400 together with the delivery request. The delivery management information includes, for example, the identification information of the user of the vehicle 10A, the identification information of the vehicle 10A, the identification information of the product A, and so on. The vehicle specification information of the vehicle 10A includes, for example, information about appearance of the vehicle 10A such as a number put on a number plate of the vehicle 10A, a vehicle type, and a color.

When the collection/delivery management server 400 receives the delivery request of delivering the product A to the vehicle 10A, the collection/delivery management server 400 determines a collection/delivery schedule and a delivery user of the product A to the vehicle 10A and transmits the collection/delivery schedule to the user terminal 50 of the delivery user. The collection/delivery schedule functions as a delivery request to the delivery user and is, for example, a time zone during which delivery is to be performed. The delivery management information of the product A and the vehicle specification information of the vehicle 10A, for example, are also transmitted together with the collection/delivery schedule. The collection/delivery management server 400 is an example of a “delivery management device.” The user terminal 50 is an example of a “terminal of a delivery user.” The collection/delivery schedule is an example of a “delivery request” to be transmitted to the “terminal of the delivery user”.

For example, in the shopping center A, a collection/delivery schedule of delivery of a purchased product to the vehicle 10A is set to a time zone subsequent to a time zone in which the delivery request has been accepted. More specifically, for example, in a case where one hour from 0 minutes to 59 minutes per hour is one time zone, a collection/delivery schedule for a delivery request accepted at 11:30 is set so that collection at the store and delivery to the vehicle 10A are performed in a subsequent time zone from 12:00 to 12:59. Accordingly, in a case where a plurality of delivery requests occurs for a plurality of products purchased by the same user at a plurality of stores in the same time zone, these deliveries are assigned to the same delivery user in a subsequent time zone and are performed as one delivery. Note that a determination method of the collection/delivery schedule is not limited to the above method.

When a start time of a collection/delivery time zone set in the collection/delivery schedule comes, the user terminal 50 of the delivery user transmits an issue request of authentication information of the vehicle 10A to the collection/delivery management server 400. The collection/delivery management server 400 transmits, to the center server 500, the issue request of the authentication information from the user terminal 50 of the delivery user.

When the center server 500 receives the issue request of the authentication information of the vehicle 10A from the user terminal 50 of the delivery user, the center server 500 acquires positional information of the vehicle 10A and transmits the authentication information and the positional information of the vehicle 10A to the user terminal 50.

When the start time of the collection/delivery time zone set in the collection/delivery schedule comes, the delivery user goes to the store A to collect the product A, and when the delivery user collects the product A, the delivery user goes to the vehicle 10A as a delivery destination of the product A. Note that the delivery user may collect and deliver products on foot in the site of the shopping center A or may use a small transportation device such as a bicycle.

At the point when the delivery user goes to the vehicle 10A with the product A, the authentication information and the positional information of the vehicle 10A have been already received by the user terminal 50, so that the delivery user can arrive at a parking position of the vehicle 10A based on the positional information of the vehicle 10A without being at a loss. Further, when the delivery user reaches the vehicle 10A, the delivery user transmits the authentication information of the vehicle 10A held by the user terminal 50 to the vehicle 10A to unlock the door of the vehicle 10A, so that the delivery user can place the product A in a trunk room, on a seat, and the like of the vehicle 10A, for example.

In the meantime, after the user of the vehicle 10A purchases the product A at the store A, the user can do shopping or have a meal at other stores in the shopping center A without carrying the product A. Meanwhile, the product A is delivered to the vehicle 10A, and when the user of the vehicle 10A returns to the vehicle 10A, the product A is stored in the vehicle 10A.

The site of the shopping center A is an example of a “delivery coverage area including a plurality of stores.” The example of the “delivery coverage area including a plurality of stores” is not limited to this, and a range defined by a management organization of a shopping street including stores is also an example of the “delivery coverage area including a plurality of stores.” The delivery request transmitted from the user terminal 200 to the center server 500 is an example of the “delivery request.”

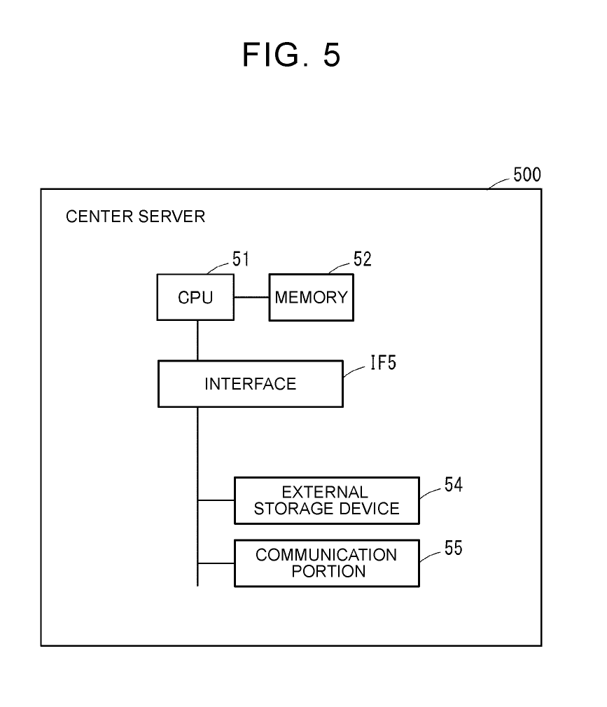

FIG. 5 is a view illustrating an example of a hardware configuration of the center server 500. The center server 500 includes a CPU 51, a memory 52, an interface IFS, an external storage device 54, and a communication portion 55. The CPU 51 executes a computer program which is loaded in the memory 52 in an executable way and executes a process as the center server 500. The computer program executed by the CPU 51, data processed by the CPU 51, and the like are stored in the memory 52. The memory 52 is, for example, a dynamic random access memory (DRAM), a static random access memory (SRAM), a read only memory (ROM), and the like.

The external storage device 54 and the communication portion 55 are connected to the interface IFS. The external storage device 54 is a nonvolatile storage device and is, for example, a solid state drive (SSD), a hard disk drive, and the like. The communication portion 55 is connected to a public communication network through the LAN and communicates with various servers on the network, the user terminal 200, and the vehicle 10A through the public communication network.

In FIG. 5, the interface IFS is exemplified, but transmission and reception of a signal between the CPU 51 and a control target is not limited to the interface IFS. That is, the CPU 51 may have a plurality of signal transmission/reception paths other than the interface IFS. Further, in FIG. 5, the center server 500 includes a single CPU 51. Note that the CPU is not limited to a single processor and may have a multiprocessor configuration. Further, a single CPU connected by a single socket may have a multi-core configuration. At least some processes of the above portions may be performed by a processor other than the CPU, e.g., a special purpose processor such as a digital signal processor (DSP) or a graphics processing unit (GPU). Further, at least some processes of the above portions may be performed by an integrated circuit (IC) or other digital circuits. Further, an analog circuit may be included in at least some of the above portions.

A hardware configuration of the collection/delivery management server 400 is generally the same as the center server 500, so the hardware configuration is not illustrated herein. The collection/delivery management server 400 includes a CPU, a memory, an external storage device, and a communication portion as a hardware configuration, and the CPU executes a computer program which is loaded in the memory in an executable way and executes a process as the collection/delivery management server 400.

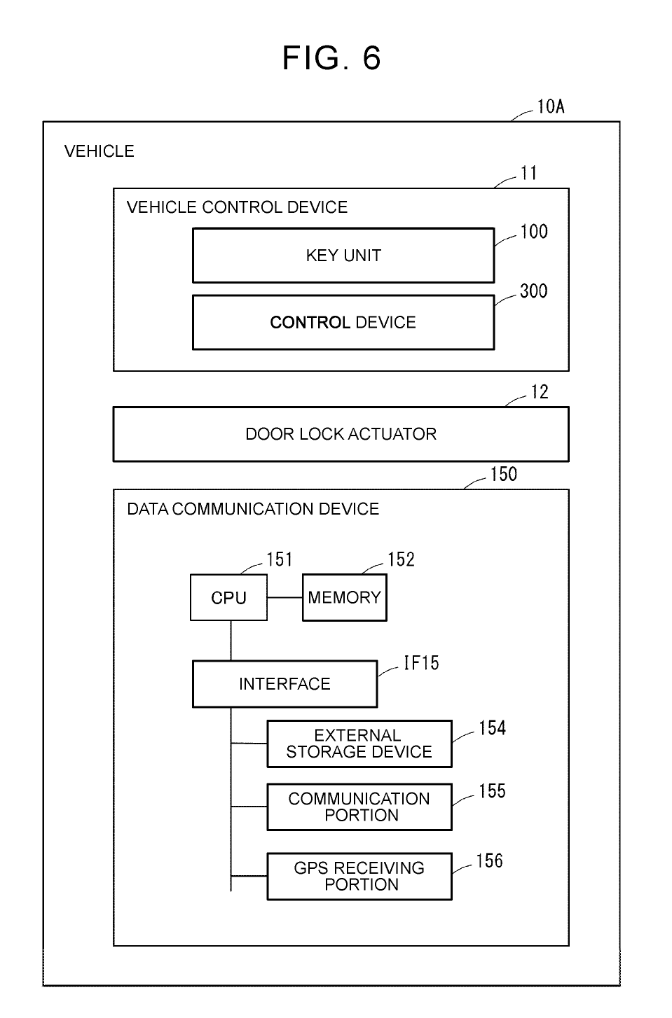

FIG. 6 is a view illustrating an example of a hardware configuration of the vehicle 10A. Note that FIG. 6 extracts and illustrates a hardware configuration related to the control of the vehicle 10A and a configuration (an engine and the like) related to running is omitted. The vehicle 10A includes the vehicle control device 11, the door lock actuator 12, and a data communication device 150. The vehicle control device 11 and the door lock actuator 12 are configured as described above. The data communication device 150 is, for example, a device having a communication function with other devices such as the center server 500.

The data communication device 150 includes, for example, a CPU 151, a memory 152, an interface IF15, an external storage device 154, a communication portion 155, and a global positioning system (GPS) receiving portion 156. Configurations and operations of the CPU 151, the memory 152, the interface IF15, the external storage device 154, and the communication portion 155 are similar to those of the CPU 51, the memory 52, the interface IFS, the external storage device 54, and the communication portion 55 illustrated in FIG. 5.

The GPS receiving portion 156 receives a radio wave of a time signal from a plurality of global positioning satellites going around the earth and stores the time signal in a register (not shown) of the CPU 151. The CPU 151 calculates latitude and longitude as a position on the earth from a detection signal from the GPS receiving portion 156, for example, so as to acquire positional information of the vehicle 10A.

Note that the data communication device 150 is electrically connected to the vehicle control device 11 via CAN or the like, for example. Accordingly, the data communication device 150 may receive a notification indicating that the door of the vehicle 10 is locked and unlocked from the vehicle control device 11 and may transmit the notification to the center server 500.

The hardware configuration of the vehicle 10A illustrated in FIG. 6 is an example and is not limited to the configuration illustrated in FIG. 6. For example, the data communication device 150 may include a portable recording medium driving device, so as to perform a process by reading a program or data stored in a portable recording medium. The portable recording medium is, for example, a flexible disk, a magneto-optical disk, a CD-ROM, a CD-R/W, a DVD, a Blu-ray disk, a DAT, an 8-mm tape, a memory card such as a flash memory, and the like.

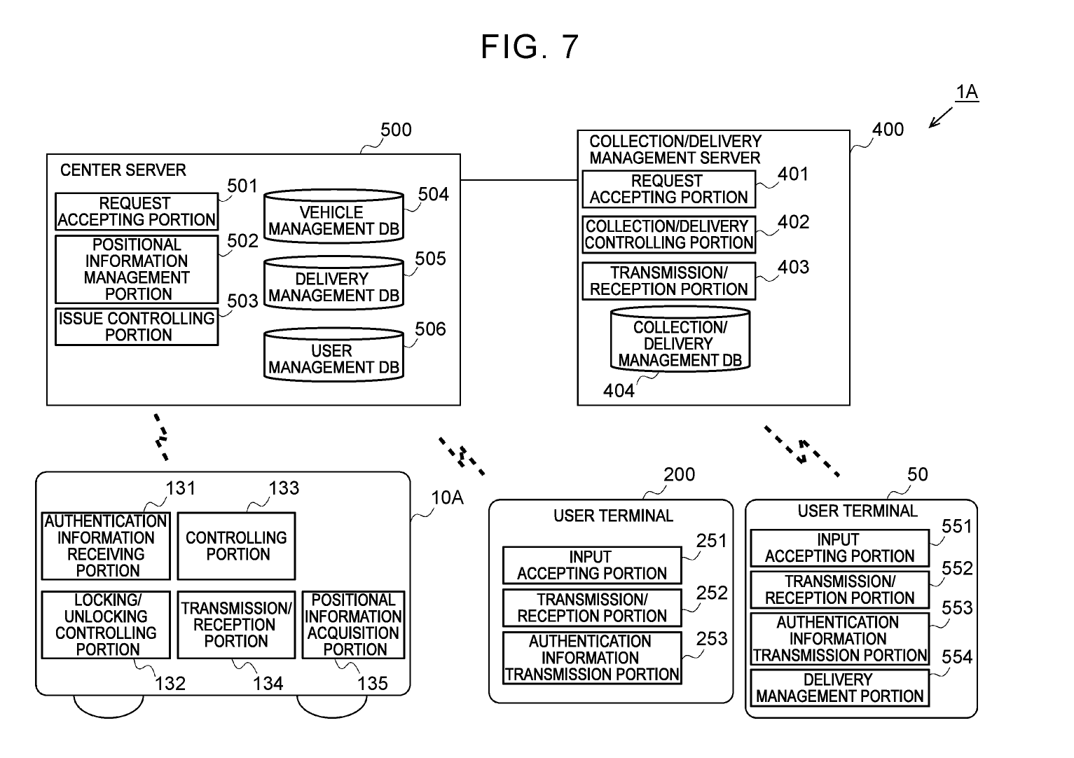

FIG. 7 is a view illustrating an example of functional configurations of the center server 500, the collection/delivery management server 400, the vehicle 10A, the user terminal 200 of the user of the vehicle 10A, and the user terminal 50 of the delivery user in the purchased product delivery system 1A according to the first embodiment. The center server 500 operates as each part exemplified in FIG. 7 by a computer program in the memory 52. That is, the center server 500 includes a request accepting portion 501, a positional information management portion 502, an issue controlling portion 503, a vehicle management data base (DB) 504, a delivery management DB 505, and a user management DB 506 as functional constituents.

The request accepting portion 501 executes an acceptance process of accepting a delivery request of a purchased product to the vehicle 10A from the user terminal 200, for example. Information about the purchased product, identification information of the vehicle 10A as a delivery destination, and identification information of the user are also transmitted from the user terminal 200 together with the delivery request, for example. Note that information transmitted together with the delivery request of the purchased product to the vehicle 10A is not limited to these pieces of information. For example, the information transmitted together with the delivery request may include vehicle specification information of the vehicle 10A.

In the acceptance process of accepting the delivery request, the request accepting portion 501 determines whether the received delivery request is accepted or not, and when it is determined that the delivery request is acceptable, the request accepting portion 501 transmits the delivery request to the collection/delivery management server 400. Delivery management information of the purchased product, vehicle specification information of the vehicle 10A, and the like are also transmitted together with the delivery request.

More specifically, the request accepting portion 501 determines whether or not the user of the user terminal 200 as a transmission source of the delivery request is registered in the user management DB 506 as a user who can receive the service provided by the center server 500. When the user of the user terminal 200 as the transmission source of the delivery request is registered in the user management DB 506 as a user who can receive the service provided by the center server 500, the request accepting portion 501 determines that the delivery request is acceptable. The request accepting portion 501 registers the content of the delivery request in the delivery management DB 505. The request accepting portion 501 is an example of a function of the “key information management device” and an example of a function of the “delivery management system.”

The positional information management portion 502, for example, receives positional information transmitted, at a predetermined cycle, from the vehicle 10A authentication information of which is managed by the center server 500, and registers it in the vehicle management DB 504 (described later). The positional information management portion 502 is an example of a function of the “key information management device” and an example of a function of the “delivery management system.”

The issue controlling portion 503, for example, receives an issue request of authentication information of the vehicle 10A from the user terminal 50 of the delivery user via the collection/delivery management server 400. The issue controlling portion 503 acquires the authentication information of the vehicle 10A as a target of the issue request from the vehicle management DB 504 (described later) and issues and transmits authentication information for the user terminal 50 based on the authentication information of the vehicle 10A. Further, upon receipt of a delivery completion notification from the user terminal 50 of the delivery user via the collection/delivery management server 400, the issue controlling portion 503, for example, performs an authentication information invalidation process on the user terminal 50 as a transmission destination of the authentication information of the vehicle 10A. The issue controlling portion 503 is an example of a function of the “key information management device” and an example of a function of the “delivery management system.”

The vehicle management DB 504, the delivery management DB 505, and the user management DB 506 are formed inside the external storage device 54 of the center server 500, for example. A vehicle management information table holding information about the vehicle 10A the authentication information of which is managed by the center server 500 is stored in the vehicle management DB 504, for example. The information about the vehicle 10A also includes the authentication information of the vehicle 10A. Details of the vehicle management information table will be described later. The vehicle management DB 504 is an example of a function of the “key information management device” and an example of a function of the “delivery management system.”

A delivery management information table holding delivery management information about a delivery request accepted by the center server 500 is stored in the delivery management DB 505, for example. The delivery management information includes, for example, identification information of the user as a delivery request source, identification information of the vehicle 10A as a delivery destination, information about a package (a purchased product) to be delivered, and so on. Details of the delivery management information table will be described later.

The user management DB 506 holds, for example, information about the user of the vehicle 10A and information about a user to whom authentication information can be issued. The information about the user of the vehicle 10A includes, for example, identification information of the user of the vehicle 10A and identification information of the user terminal 200. Note that the information about the user of the vehicle 10A is not limited to this. The information about the user of the vehicle 10A, held in the user management DB 506, may include, for example, information indicating whether or not the user can receive a delivery service of a purchased product to the vehicle 10A. Whether or not the user of the vehicle 10A can receive a delivery service of a purchased product to the vehicle 10A is determined, for example, based on whether or not the user of the vehicle 10A subscribes the delivery service of a purchased product to the vehicle 10A about the user terminal 200.

The information about the user to whom authentication information can be issued, held in the user management DB 506, is information about the collection/delivery management server 400 cooperating with the center server 500 in the purchased product delivery system 1A, for example. The information about the collection/delivery management server 400 includes identification information of the collection/delivery management server 400, for example. Note that the information about the collection/delivery management server 400 is not limited to this and may include identification information of the user terminal 50 of the delivery user of the parcels delivery company that manages the collection/delivery management server 400 for example.

In the first embodiment, the issue request of authentication information from the user terminal 50 of the delivery user is once terminated at the collection/delivery management server 400 and is transmitted to the center server 500 from the collection/delivery management server 400. That is, from the center server 500, the issue request of authentication information looks as if it is transmitted from the collection/delivery management server 400. Accordingly, when the information about the collection/delivery management server 400 is stored in the user management DB 506 as the information about the user to whom authentication information can be issued, the issue controlling portion 503 issues authentication information of the vehicle 10A with respect to the issue request of authentication information from the user terminal 50 of the delivery user via the collection/delivery management server 400. Note that a communication form between the user terminal 50 of the delivery user and the center server 500 via the collection/delivery management server 400 is not limited to this.

Any of the functional constituents of the center server 500 or some of processes thereof may be executed by other computers connected to the network. Further, a series of processes executed by the center server 500 can be executed by hardware and can be also executed by software.

Then, the collection/delivery management server 400 operates as each part exemplified in FIG. 7 by a computer program in the memory. That is, the collection/delivery management server 400 includes a request accepting portion 401, a collection/delivery controlling portion 402, a transmission/reception portion 403, and a collection/delivery management DB 404 as functional constituents.

The request accepting portion 401 receives, from the center server 500, a delivery request of a purchased product to the vehicle 10A in terms of the user terminal 200, for example. Delivery management information of the product A, vehicle specification information of the vehicle 10A, and the like are also transmitted from the center server 500 together with the delivery request. The request accepting portion 401 is an example of a function of the “delivery management device.”

The collection/delivery controlling portion 402 manages, for example, delivery for the delivery request received from the center server 500. More specifically, the collection/delivery controlling portion 402 sets a collection/delivery schedule for the delivery request received from the center server 500 and determines a delivery user who performs collection/delivery. The collection/delivery controlling portion 402 transmits the collection/delivery schedule of the delivery request, the delivery management information of the delivery request, and the vehicle specification information of the vehicle 10A to the user terminal 50 of the delivery user thus determined, via the transmission/reception portion 403. Further, the collection/delivery controlling portion 402 also manages the collection/delivery management DB 404.

The transmission/reception portion 403 is an interface with the user terminal 50. The transmission/reception portion 403 transmits the collection/delivery schedule and the like to the user terminal 50 and receives an issue request of authentication information and a delivery completion notification from the user terminal 50. Upon receipt of the issue request of authentication information from the user terminal 50, the transmission/reception portion 403 transmits the issue request of authentication information to the center server 500. Further, when the transmission/reception portion 403 receives, from the center server 500, authentication information and positional information of the vehicle 10A corresponding to the issue request of authentication information from the user terminal 50, the transmission/reception portion 403 transmits the authentication information and the positional information to the user terminal 50. The transmission/reception portion 403 is an example of a function of the “delivery management device.” Further, the transmission/reception portion 403 can be regarded as an example of a function of the “delivery management system.”

The collection/delivery management DB 404 is formed in the external storage device of the collection/delivery management server 400, for example. The delivery management information table holding delivery management information about a delivery request accepted by the center server 500, for example, is stored in the collection/delivery management DB 404, for example. The delivery management information includes, for example, identification information of the user as a delivery request source, identification information of the vehicle 10A as a delivery destination, information about a package (a purchased product) to be delivered, and so on.

Any of the functional constituents of the collection/delivery management server 400 or some of processes thereof may be executed by other computers connected to the network. Further, a series of processes executed by the collection/delivery management server 400 can be executed by hardware and can be also executed by software.

The vehicle 10A operates as each part exemplified in FIG. 7 by a computer program in the memory. That is, the vehicle 10A includes an authentication information receiving portion 131, a locking/unlocking controlling portion 132, a controlling portion 133, a transmission/reception portion 134, and a positional information acquisition portion 135 as a functional configuration. The authentication information receiving portion 131 corresponds to the key unit 100. The locking/unlocking controlling portion 132 corresponds to the control device 300. The controlling portion 133, the transmission/reception portion 134, and the positional information acquisition portion 135 are functional configurations that are implemented by the CPU 151 of the data communication device 150 executing a computer program in the memory 152, for example.

The authentication information receiving portion 131 receives authentication information from the user terminal 200 via short distance communication and authenticates the user terminal 200 based on the authentication information, for example. When the authentication is successful, the authentication information receiving portion 131 outputs a control request from the user terminal 200 to the locking/unlocking controlling portion 132. The control request from the user terminal 200 includes a locking request, an unlocking request, and the like, for example.

The locking/unlocking controlling portion 132 performs processing such as locking/unlocking of the door of the vehicle 10A, and the like in accordance with input of the control request from the authentication information receiving portion 131.

The transmission/reception portion 134 is an interface with the center server 500 and is configured to transmit data input from other functional constituents to the center server 500 and to output data received from the center server 500 to the controlling portion 133, for example.

The positional information acquisition portion 135 acquires, at a predetermined cycle, positional information of the vehicle 10A acquired by the GPS receiving portion 156 or the like of the data communication device 150 and transmits it to the center server 500. The positional information of the vehicle 10A is, for example, latitude and longitude. Alternatively, the positional information of the vehicle 10A may be, for example, an address.

Further, when the controlling portion 133 is informed of unlocking or locking of the door from the locking/unlocking controlling portion 132, for example, the controlling portion 133 transmits an unlocking notification or a locking notification to the center server 500 via the transmission/reception portion 134.

The user terminal 200 of the user of the vehicle 10A operates as each part exemplified in FIG. 7 by a computer program in the memory. That is, the user terminal 200 includes an input accepting portion 251, a transmission/reception portion 252, and an authentication information transmission portion 253 as functional configurations.

The input accepting portion 251 accepts a user operation from a user interface such as a touch panel, for example. In the first embodiment, the user operation input into the user terminal 200 includes an input operation of a delivery request of a purchased product to the vehicle 10A, an input operation of locking or unlocking of the vehicle 10A, and the like.

The transmission/reception portion 252 is an interface with the center server 500. For example, when an input operation of a delivery request of a purchased product to the vehicle 10A is accepted by the input accepting portion 251, the transmission/reception portion 252 transmits the delivery request to the center server 500.

When an input operation of locking or unlocking of the vehicle 10A is accepted by the input accepting portion 251, the authentication information transmission portion 253 transmits a locking request or an unlocking request and authentication information stored in the memory to the vehicle 10A.

The user terminal 50 of the delivery user operates as each part exemplified in FIG. 7 by a computer program in the memory. That is, the user terminal 50 includes an input accepting portion 551, a transmission/reception portion 552, an authentication information transmission portion 553, and a delivery management portion 554 as a functional configuration. The input accepting portion 551 and the authentication information transmission portion 553 of the user terminal 50 have functions similar to the functions of the input accepting portion 251 and the authentication information transmission portion 253 of the user terminal 200.

In the first embodiment, the user operation input into the user terminal 50 includes an input operation of delivery completion of a purchased product to the vehicle 10A, an input operation of locking or unlocking of the vehicle 10A, and the like.

The transmission/reception portion 552 is an interface with the collection/delivery management server 400. For example, the transmission/reception portion 552 transmits, to the collection/delivery management server 400, an issue request of authentication information of the vehicle 10A and a delivery completion notification indicating that delivery to the vehicle 10A is completed. For example, the transmission/reception portion 552 receives a collection/delivery schedule assigned to the delivery user of the user terminal 50 and authentication information of the vehicle 10A from the collection/delivery management server 400. The received authentication information of the vehicle 10A is stored in the memory, for example.

When a start time of a collection/delivery time zone designated by the collection/delivery schedule comes, the delivery management portion 554 generates an issue request of authentication information of the vehicle 10A designated by the collection/delivery schedule and outputs it to the transmission/reception portion 552. Further, when an input operation of delivery completion of the purchased product to the vehicle 10A is accepted by the input accepting portion 551, the delivery management portion 554 generates a delivery completion notification and outputs it to the transmission/reception portion 552.

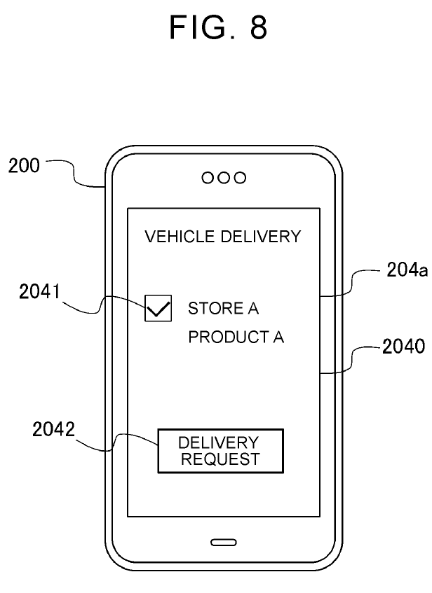

FIG. 8 illustrates an example of a setting screen, of the user terminal 200, for a delivery request of a purchased product to the vehicle 10A. The setting screen for a delivery request of a purchased product to the vehicle 10A is, for example, displayed when the setting screen is selected, on the user terminal 200, from a menu of an application to receive the service provided by the center server 500.

The setting screen for a delivery request includes, for example, a check box 2041 to select a delivery target among purchased products of the user of the vehicle 10A, and a delivery request button 2042. As a purchased product of the user of the vehicle 10A, a product purchased at a previous purchase store may be displayed or a list of purchased products for which a delivery request has not been made in a purchase history in the shopping center A on the day may be displayed, for example. Information about a purchased product may be directly input by the user or may be acquired by reading, by the user terminal 200, a bar code or a QR Code (registered trademark) shown on a receipt. Further, in a case where the purchase history is displayed, the information about a purchased product may be acquired by referring to a server or the like that manages a sales volume record of each store in the shopping center A.

When the delivery request button 2042 is selected, a user operation for a delivery request to the user terminal 200 is input. When the delivery request button 2042 is selected, a delivery request to the vehicle 10A is transmitted from the transmission/reception portion 252 to the center server 500 in terms of a product the check box 2041 of which is checked. Note that the setting screen for a delivery request illustrated in FIG. 8 is an example and is not limited to the example illustrated in FIG. 8.

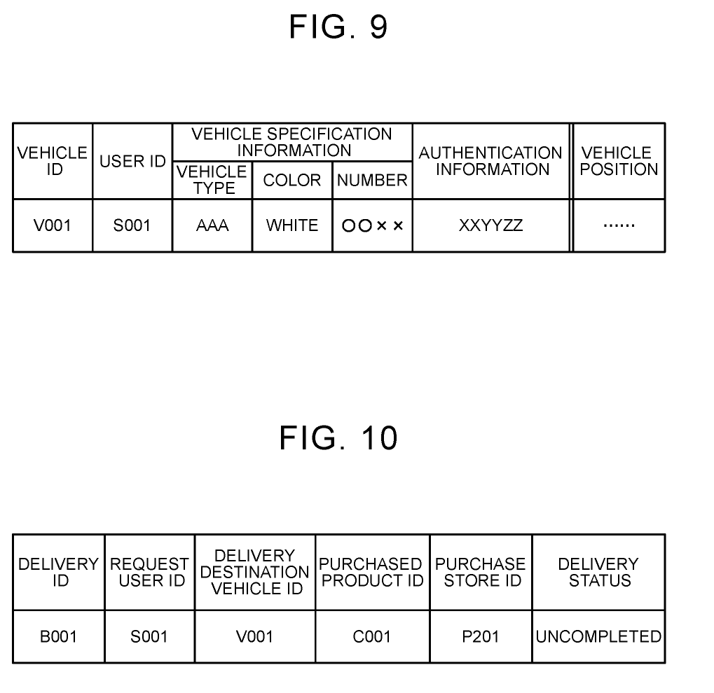

FIG. 9 is an example of the vehicle management information table. The vehicle management information table is stored in the vehicle management DB 504 of the center server 500. The vehicle management information table includes a vehicle ID field, a user ID field, a vehicle specification information field, an authentication information field, and a vehicle position field.

An identification number associated with each vehicle 10A is input in the vehicle ID field. As the identification number of the vehicle 10A, any of a name set by the user, a number set on a system side, a number put on a number plate may be used, for example.

Identification information of the user of the vehicle 10A having an identification number of a corresponding vehicle ID field is input into the user ID field. As the identification information of the user, any of a user name set by the user, an alphanumeric identification number set on the system side, a phone number or an E-mail address of the user terminal 200, and the like may be used, for example.

Information that can specify a vehicle is input into the vehicle specification information field. The vehicle specification information field has subfields of a vehicle type, a color, and a number (a vehicle registration number). Note that the subfields included in the vehicle specification information field are not limited to them. For example, in the first embodiment, upon receipt of a delivery request of a purchased product to the vehicle 10A, the request accepting portion 501 transmits information stored in the vehicle specification information field, corresponding to the vehicle 10A, to the collection/delivery management server 400 as vehicle specification information together with the delivery request.

Authentication information used for the key system is input into the authentication information field. The authentication information transmitted to the user terminal 200 is based on authentication information stored in the authentication information field. The authentication information transmitted to the user terminal 50 of the delivery user may be a one-time key, a limited key that is valid only during a predetermined time zone, or the like, for example. Further, regardless of the type of authentication information, authentication information corresponding to the above authentication information is stored in the key unit 100 in advance. The issue controlling portion 503 reads authentication information input into the authentication information field corresponding to the vehicle 10A and transmits it to the user terminal 50. Note that, in a case where the authentication information transmitted to the user terminal 50 is a one-time key or the like, the issue controlling portion 503 generates authentication information to be transmitted to the user terminal 50 by use of the authentication information input in the authentication information field corresponding to the vehicle 10A and transmits it to the user terminal 50.

Positional information of the vehicle 10A is input in the vehicle position field. The positional information of the vehicle 10A is transmitted from the vehicle 10A to the center server 500 at a predetermined cycle, for example. Upon receipt of the positional information from the vehicle 10A, the positional information management portion 502 of the center server 500 updates a value in the vehicle position field corresponding to the vehicle 10A in the vehicle management information table by the positional information thus received.

FIG. 10 is an example of the delivery management information table. The delivery management information table is stored in the delivery management DB 505 of the center server 500. The delivery management information table has a delivery ID field, a request user ID field, a delivery destination vehicle ID field, a purchased product ID field, a purchase store ID field, and a delivery status field.

Identification information of a delivery request is input in the delivery ID field. The identification information of the delivery request is given by the request accepting portion 501, for example. Identification information of a user as a transmission source of the delivery request is input in the request user ID field. An identification number of the vehicle 10A as a delivery destination is input in the delivery destination vehicle ID field. Identification information of a purchased product is input in the purchased product ID field. Identification information of a purchase store is input in the purchase store ID field.

The identification information of the user as the transmission source of the delivery request and the identification information of the vehicle 10A as the delivery destination are transmitted to the center server 500 together with the delivery request, for example. The identification information of the purchased product and the identification information of the purchase store are included in information about the purchased product, transmitted to the center server 500 together with the delivery request, for example.

In the delivery status field, “UNCOMPLETED” or “COMPLETED” is input, for example. An initial value of the delivery status field is “UNCOMPLETED.” When a delivery completion notification is received from the user terminal 50 of the delivery user via the collection/delivery management server 400 in terms of a delivery request of identification information corresponding to a value of the delivery ID field, a value of the delivery status field is updated to “COMPLETED” by the issue controlling portion 503, for example.

Note that a combination of values in the delivery ID field, the request user ID field, the delivery destination vehicle ID field, the purchased product ID field, and the purchase store ID field in the delivery management information table is called delivery management information and is information transmitted together with the delivery request to be transmitted from the center server 500 to the collection/delivery management server 400. Accordingly, in the first embodiment, the delivery management information table stored in the collection/delivery management DB 404 of the collection/delivery management server 400 has at least a data structure similar to the delivery management information table illustrated in FIG. 10.

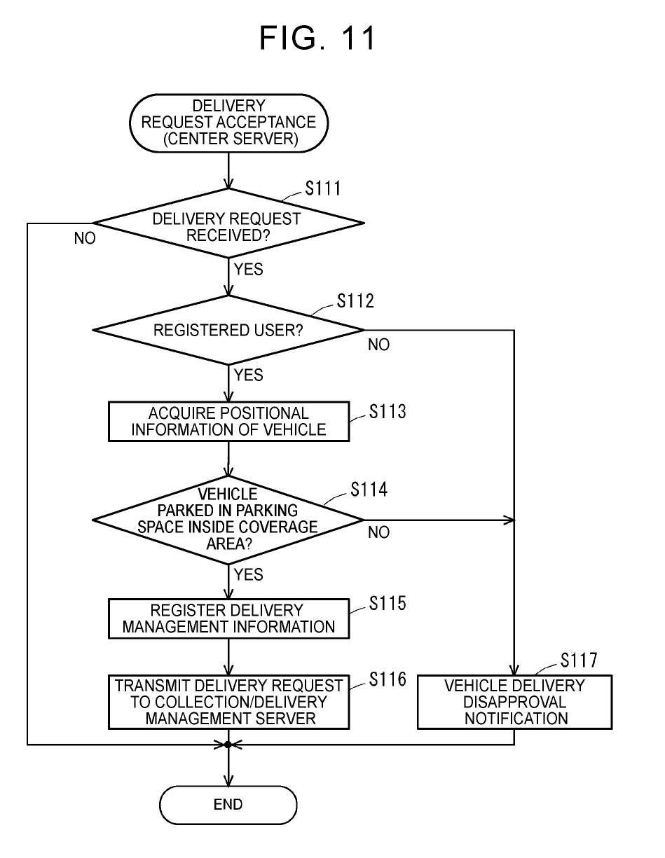

FIG. 11 illustrates an example of a flowchart of a request acceptance process of the request accepting portion 501 of the center server 500 according to the first embodiment. The process illustrated in FIG. 11 is performed repeatedly at a predetermined cycle, for example. A main body of the process illustrated in FIG. 11 is the CPU 51 provided in the center server 500, but for convenience, the following description deals with the request accepting portion 501 that is a functional constituent, as the main body. Flowcharts described in any figures after FIG. 11 will be also described with corresponding functional constituents as their main bodies.

In S111, the request accepting portion 501 determines whether a delivery request is received or not. When the delivery request is received (S111: YES), the process proceeds to S112. When the delivery request is not received (S111: No), the process illustrated in FIG. 11 is ended.

In S112, the request accepting portion 501 determines whether the user of the user terminal 200 as a transmission source of the delivery request is the user of the vehicle 10A or not. For example, identification information of the user of the user terminal 200 as a request source and identification information of the vehicle 10A as a delivery destination are received together with the delivery request, so the request accepting portion 501 performs the determination in S112 based on whether the correspondence between the received identification information of the user terminal 200 and the received identification information of the vehicle 10A is registered in the user management DB 506 or not. The process of S112 functions as simple user authentication.

When the user of the user terminal 200 as the transmission source of the delivery request is the user of the vehicle 10A (S112: YES), the process proceeds to S113. When the user of the user terminal 200 as the transmission source of the delivery request is not the user of the vehicle 10A (S112: NO), the process proceeds to S117. In S117, a vehicle delivery disapproval notification is transmitted to the user terminal 200 as the transmission source of the delivery request. After that, the process illustrated in FIG. 11 is ended.

In S113, the request accepting portion 501 acquires positional information of the vehicle 10A. The positional information of the vehicle 10A may be acquired from the vehicle management DB 504 or may be acquired from the vehicle 10A by transmitting an acquisition request of positional information to the vehicle 10A, for example.

In S114, the request accepting portion 501 determines whether or not the vehicle 10A is parked in a parking space in the site (“INSIDE COVERAGE AREA” in the figure) of the shopping center A. For example, the center server 500 holds, in advance in the memory 52, a map of the shopping center A, positional information of the parking space in the shopping center A, and the like. The request accepting portion 501 performs the determination in S114 based on the positional information of the vehicle 10A and the positional information of the parking space in the shopping center A.

When the vehicle 10A is parked in the parking space in the site (“INSIDE COVERAGE AREA” in the figure) of the shopping center A (S114: YES), the process proceeds to S115. When the vehicle 10A is not parked in the parking space in the site (“INSIDE COVERAGE AREA” in the figure) of the shopping center A (S114: NO), the process proceeds to S117. In S117, the request accepting portion 501 transmits a vehicle delivery disapproval notification to the user terminal 200. After that, the process illustrated in FIG. 11 is ended. The processes of S113 and S114 are a process of checking that the vehicle 10A is present in the coverage area of the delivery service of a purchased product to a vehicle.

In S115, the request accepting portion 501 registers delivery management information about the delivery request in the delivery management DB 505. Hereby, the delivery request is accepted.

In S116, the request accepting portion 501 transmits the delivery request to the collection/delivery management server 400. The delivery management information and vehicle specification information are also transmitted together with the delivery request. The vehicle specification information is acquired from the vehicle management DB 504. After that, the process illustrated in FIG. 11 is ended.

Note that the request acceptance process illustrated in FIG. 11 is an example, and the request acceptance process is not limited to this. The process of S112 and the processes from S113 to S114 are optional and may be omitted depending on the embodiment.

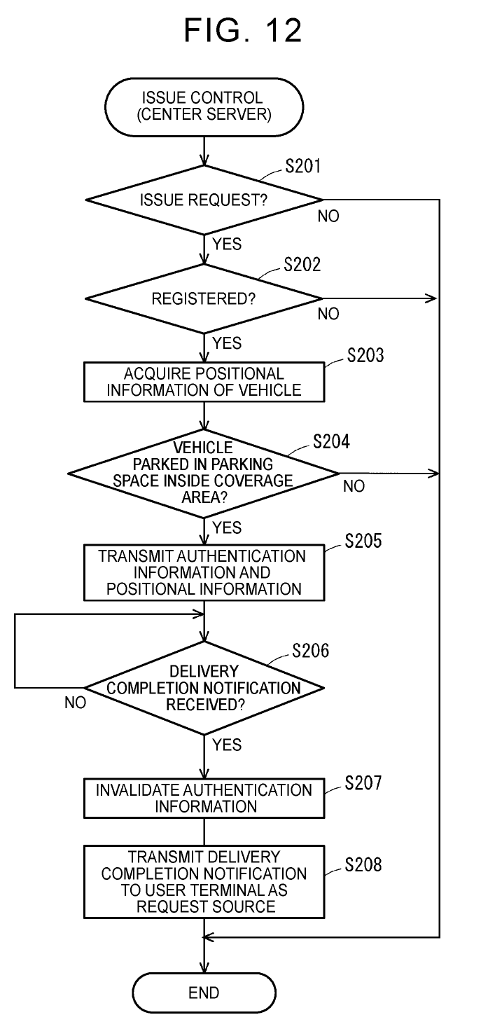

FIG. 12 illustrates an example of a flowchart of an issue controlling process of the issue controlling portion 503 of the center server 500 according to the first embodiment. The process illustrated in FIG. 12 is performed repeatedly at a predetermined cycle, for example.

In S201, the issue controlling portion 503 determines whether an issue request of authentication information of the vehicle 10A is received or not. Identification information of a delivery request, identification information of the vehicle 10A as a delivery destination, and the like, for example, are also received together with the issue request of authentication information. When the issue request of authentication information of the vehicle 10A is received (S201: YES), the process proceeds to S202. When the issue request of authentication information of the vehicle 10A is not received (S201: NO), the process illustrated in FIG. 12 is ended.

In S202, the issue controlling portion 503 determines whether or not a target delivery request corresponding to the issue request of authentication information is registered in the delivery management DB 505. When the target delivery request corresponding to the issue request of the authentication information is registered in the delivery management DB 505 (S202: YES), the process proceeds to S203. When the target delivery request corresponding to the issue request of the authentication information is not registered in the delivery management DB 505 (S202: NO), the process illustrated in FIG. 12 is ended. S202 is a process of checking whether the issue request of authentication information is proper or not.

In S203, the issue controlling portion 503 acquires positional information of the vehicle 10A. The positional information of the vehicle 10A may be acquired from the vehicle management DB 504 or may be acquired from the vehicle 10A by transmitting an acquisition request of positional information to the vehicle 10A, for example.

In S204, the issue controlling portion 503 determines whether or not the vehicle 10A is parked in the parking space in the site (“INSIDE COVERAGE AREA” in the figure) of the shopping center A. When the vehicle 10A is parked in the parking space in the site (“INSIDE COVERAGE AREA” in the figure) of the shopping center A (S204: YES), the process proceeds to S205. When the vehicle 10A is not parked in the parking space in the site (“INSIDE COVERAGE AREA” in the figure) of the shopping center A (S204: NO), the process illustrated in FIG. 12 is ended. The process of S204 is a process of checking that the vehicle 10A is present in the coverage area of the delivery service of a purchased product to a vehicle.

In S205, the issue controlling portion 503 issues authentication information of the vehicle 10A to the user terminal 50 of the delivery user as a request source and transmits the authentication information of the vehicle 10A and the positional information acquired in S203 to the user terminal 50 of the delivery user via the collection/delivery management server 400. The authentication information of the vehicle 10A is acquired from the vehicle management DB 504, for example.

In S206, the issue controlling portion 503 determines whether a delivery completion notification is received or not. The delivery completion notification is generated such that the delivery user inputs delivery completion into the user terminal 50, for example, and the delivery completion notification is transmitted from the user terminal 50 via the collection/delivery management server 400. The identification information of the delivery request, for example, is also received together with the delivery completion notification. When the delivery completion notification is received (S206: YES), the process proceeds to S207. When the delivery completion notification is not received (S206: NO), the process proceeds to S206 again. In a case where reception of the delivery completion notification is not detected even when a predetermine time has elapsed, for example, the process may proceed to S207.

In S207, the issue controlling portion 503 performs an invalidation process of invalidating the authentication information of the vehicle 10A. The content of the invalidation process is not limited particularly, provided that the delivery user cannot lock and unlock the vehicle 10A by the authentication information that has been already issued, but examples of the invalidation process are as follows.

(1) The center server 500 orders the user terminal 50 to delete the authentication information. (2) The center server 500 orders the user terminal 50 to raise an invalidation flag with respect to the authentication information. In this case, the user terminal 50 does not transmit, to the vehicle 10A, the authentication information to which the invalidation flag is raised, via short-distance wireless communication. (3) The center server 500 orders the user terminal 50 to rewrite an expiry date included in the authentication information to past date and time. (4) The center server 500 orders the user terminal 50 to recognize the authentication information is invalid and not to transmit the authentication information to the vehicle 10A. (5) The center server 500 commands, via the data communication device 150, the key unit 100 to recognize that the authentication information is invalid and not to receive the authentication information. (6) The center server 500 commands, via the data communication device 150, the key unit 100 not to receive authentication information from the user terminal 50.

The invalidation processes of (1) to (4) are a process performed by the center server 500 on the user terminal 50, and the invalidation processes of (5) to (6) are a process performed by the center server 500 on the key unit 100. As the invalidation process, either of the process performed on the user terminal 50 and the process performed on the key unit 100 may be performed, or both of the processes are preferably performed because the communication between the user terminal 50 and the center server 500 and the communication between the data communication device 150 and the center server 500 may not be always in a good state.

In S208, the issue controlling portion 503 transmits a delivery completion notification to the user terminal 200 as a request source. Further, the issue controlling portion 503 updates a value of the delivery status field corresponding to the delivery request in the delivery management information table to “COMPLETED”. After that, the process illustrated in FIG. 12 is ended.

Note that the process of the issue controlling portion 503 as illustrated in FIG. 12 is an example and is not limited to this. For example, the process of S202 and the process of S204 are optional and may be omitted depending on the embodiment.

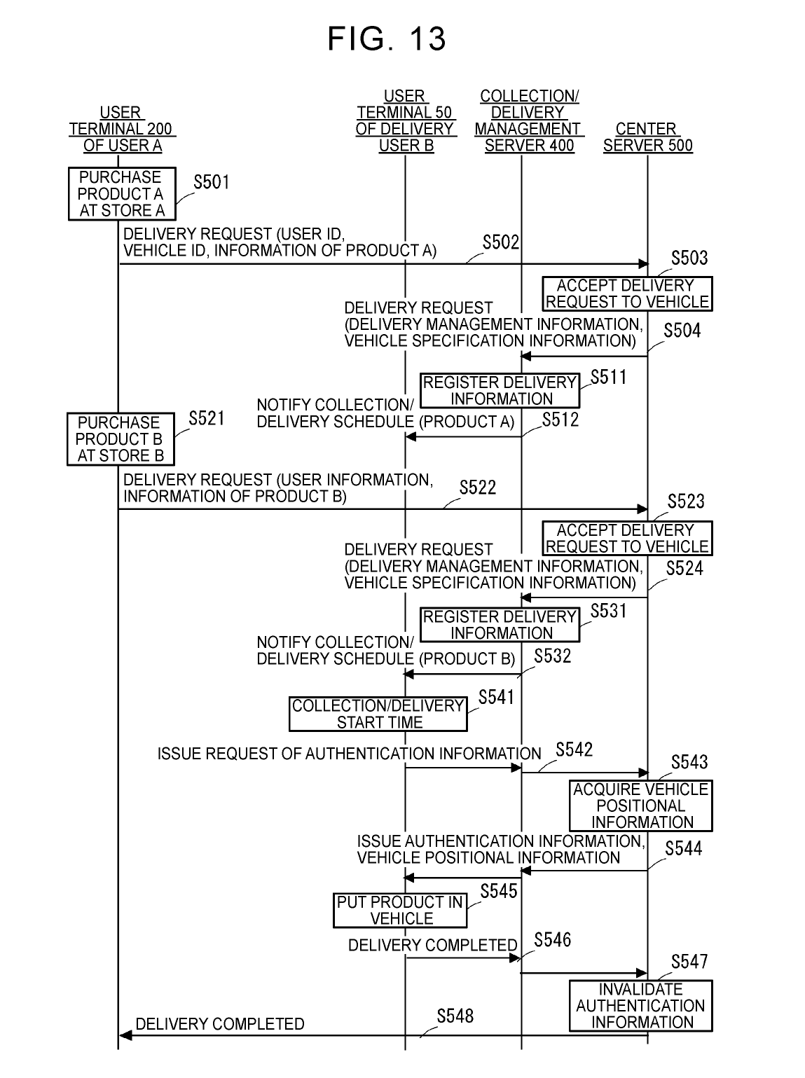

FIG. 13 illustrates an example of a processing sequence in a concrete example of the first embodiment. The concrete example deals with an example in which a user A purchases the product A at the store A and purchases a product B at a store B in the shopping center A during the same time zone, and the user A requests delivery of the purchased products to the vehicle 10A. It is premised that identification information of the user A and identification information of the vehicle 10A are registered in the user management DB 506 of the center server 500. Further, it is premised that the vehicle 10A is parked in the parking space of the shopping center A.

In S501, the user A purchases the product A at the store A in a time zone #1 and performs a user operation for a delivery request of delivering the product A to the vehicle 10A on the user terminal 200. In S502, the user terminal 200 transmits, to the center server 500, the delivery request of delivering the product A to the vehicle 10A, and the center server 500 receives the delivery request (FIG. 11, S111: YES). The identification information of the user A, the identification information of the vehicle 10A, and information about the product A are also transmitted together with the delivery request.

In S503, the center server 500 determines that the identification information of the user A and the identification information of the vehicle 10A are registered in the user management DB 506 (FIG. 11, S112: YES) and the vehicle 10A is parked in the parking space of the shopping center A (FIG. 11, S114: YES), and the center server 500 accepts the delivery request from the user terminal 200. The center server 500 registers information of the delivery request in the delivery management DB 505 (FIG. 11, S115). In S504, the center server 500 transmits, to the collection/delivery management server 400, the delivery request of delivering the product A to the vehicle 10A (FIG. 11, S116). Delivery request information corresponding to the delivery request and vehicle specification information of the vehicle 10A are also transmitted together with the delivery request.

In S511, the collection/delivery management server 400 receives the delivery request of delivering the product A to the vehicle 10A from the center server 500 and registers the delivery request information in the collection/delivery management DB 404. In S512, the collection/delivery management server 400 sets a collection/delivery schedule for the delivery request of delivering the product A to the vehicle 10A to a time zone #2 subsequent to the time zone #1, determines a delivery user B as a delivery user, and transmits the collection/delivery schedule to the user terminal 50 of the delivery user B. The delivery management information of the delivery request and the vehicle specification information of the vehicle 10A are transmitted together with the collection/delivery schedule.

In S521, the user A purchases the product B at the store B in the time zone #1 and performs a user operation for a delivery request of delivering the product B to the vehicle 10A on the user terminal 200. In S522, the user terminal 200 transmits, to the center server 500, the delivery request of delivering the product B to the vehicle 10A, and the center server 500 receives the delivery request (FIG. 11, S111: YES). The identification information of the user A, the identification information of the vehicle 10A, and information about the product B are also transmitted together with the delivery request.

In S523, the center server 500 accepts the delivery request from the user terminal 200 and registers information of the delivery request in the delivery management DB 505 (FIG. 11, S112 to S115). In S524, the center server 500 transmits, to the collection/delivery management server 400, the delivery request of delivering the product B to the vehicle 10A (FIG. 11, S116). Delivery request information corresponding to the delivery request and vehicle specification information of the vehicle 10A are also transmitted together with the delivery request.

In S531, the collection/delivery management server 400 receives the delivery request of delivering the product B to the vehicle 10A from the center server 500 and registers the delivery request information in the collection/delivery management DB 404. In S532, the collection/delivery management server 400 sets a collection/delivery schedule for the delivery request of delivering the product B to the vehicle 10A to the time zone #2 subsequent to the time zone #1, and since the delivery destination of the product B is the same as the delivery destination of the product A, the collection/delivery management server 400 determines the delivery user B as a delivery user and transmits the collection/delivery schedule to the user terminal 50 of the delivery user B. The delivery management information of the delivery request and the vehicle specification information of the vehicle 10A are transmitted together with the collection/delivery schedule.

In S541, a start time of the time zone #2 as the collection/delivery schedule of the product A and the product B comes. In S542, the user terminal 50 of the delivery user B transmits an issue request of authentication information of the vehicle 10A as the delivery destination of the product A and the product B to the center server 500 via the collection/delivery management server 400, and the center server 500 receives the issue request of authentication information (FIG. 12, S201). Respective pieces of identification information of the delivery requests are also transmitted together with the issue request of authentication information.

In S543, since target delivery requests corresponding to the issue request of authentication information are registered in the delivery management DB 505 (FIG. 12, S202: YES), the center server 500 acquires positional information of the vehicle 10A (FIG. 12, S203). In S544, the center server 500 determines that the vehicle 10A is parked in the parking space in the site of the shopping center A (FIG. 12, S204: YES), and the center server 500 transmits the authentication information and the positional information of the vehicle 10A to the user terminal 50 of the delivery user B (FIG. 12, S205).

In S545, the delivery user B collects the product A at the store A, collects the product B at the store B, and then moves to a position indicated by the positional information of the vehicle 10A. Then, the delivery user B unlocks the door of the vehicle 10A by transmitting the authentication information of the vehicle 10A from the user terminal 50 and puts the product A and the product B in the vehicle 10A. Further, the delivery user B locks the door of the vehicle 10A by transmitting the authentication information of the vehicle 10A from the user terminal 50. Note that a collection method of a purchased product to be delivered is not limited to the above method in which a purchased product is collected by a delivery user and may be a method in which a salesclerk of each store brings a purchased product to a predetermined collection place.

In S546, the delivery user B inputs, into the user terminal 50, delivery completion for the delivery request of delivering the product A and for the delivery request of delivering the product B, and the user terminal 50 transmits respective delivery completion notifications for the delivery request of delivering the product A and for the delivery request of delivering the product B to the collection/delivery management server 400. The collection/delivery management server 400 transmits, to the center server 500, the respective delivery completion notifications for the delivery request of delivering the product A and for the delivery request of delivering the product B, received from the user terminal 50.

In S547, the center server 500 receives the respective delivery completion notifications for the delivery request of delivering the product A and for the delivery request of delivering the product B (FIG. 12, S206: YES) and performs an invalidation process on the authentication information of the vehicle 10A which is issued to the user terminal 50 (FIG. 12, S207). In S548, the center server 500 transmits, to the user terminal 200 of a request source, the respective delivery completion notifications for the delivery request of delivering the product A and for the delivery request of delivering the product B (FIG. 12, S208).

In the first embodiment, the center server 500 notifies to the user terminal 50 of the delivery user about the authentication information and the positional information of the vehicle 10A. Hereby, the purchased product can be delivered to the vehicle 10A in the absence of the user in the site of the shopping center A. Hereby, the user can go around stores in the shopping center A without carrying the purchased product, and the purchased product is put in the vehicle 10A until the user returns to the vehicle 10A, so that convenience of shopping in the shopping center A improves.

The positional information of the vehicle 10A to be transmitted to the user terminal 50 of the delivery user is at a start time of a time zone as a collection/delivery schedule, and therefore, the delivery user can know newer positional information of the vehicle 10A and can surely reach the vehicle 10A.

Further, in the first embodiment, the center server 500 acquires the positional information of the vehicle 10A, and when the vehicle 10A is located in a service supply area, the center server 500 transmits the authentication information of the vehicle 10A to the user terminal 50 of the delivery user. Hereby, delivery of the purchased product to the vehicle 10A in the absence of the user can be limited to the coverage area.

In a second embodiment, the service to deliver a purchased product to the vehicle 10A in the shopping center is provided by a store server prepared on the shopping center side. In the second embodiment, the same description as in the first embodiment will be omitted.

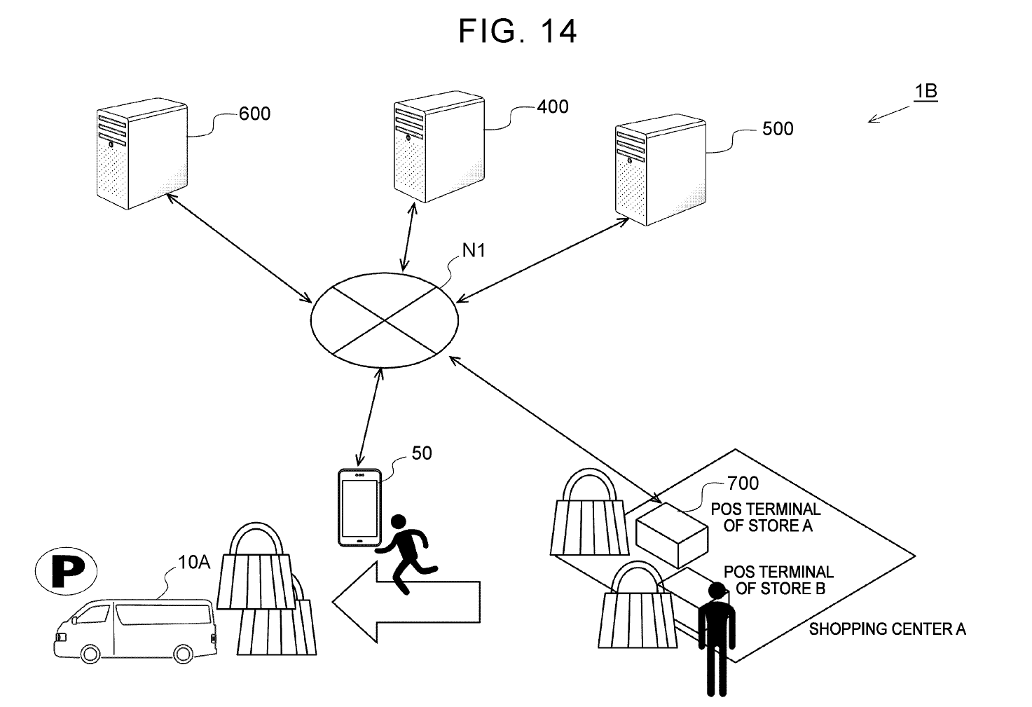

FIG. 14 is a view illustrating an example of a system configuration of a purchased product delivery system 1B according to the second embodiment. The purchased product delivery system 1B according to the second embodiment further includes the vehicle 10A, the center server 500, the collection/delivery management server 400, the user terminal 50 of the delivery user, a store server 600, and a POS terminal 700 provided in each store. In the second embodiment, the user terminal 200 of the user of the vehicle 10A may be included or may not be included in the purchased product delivery system 1B. The store server 600 is connected to the network N1 and is communicable with the center server 500 and the collection/delivery management server 400. The POS terminal 700 is connected to the network N1 or the LAN in the shopping center A and communicates with the store server 600, for example.

In the second embodiment, the POS terminal 700 transmits a delivery request of a purchased product to the vehicle 10A, and the store server 600 accepts the delivery request. The store server 600 transmits the delivery request to the center server 500 and the collection/delivery management server 400. The process to be performed after that is almost the same as the first embodiment.

One or more POS terminals 700 are provided in each store in the shopping center A, for example. When an input operation of a delivery request of a purchased product to the vehicle 10A is performed by an operation by a salesclerk of a store, for example, the POS terminal 700 transmits, to the store server 600, the delivery request of the purchased product to the vehicle 10A. Information transmitted to the store server 600 together with the delivery request is similar to that in the first embodiment.

That is, information about the purchased product, identification information of the vehicle 10A, and identification information of the user are also transmitted together with the delivery request, for example. The salesclerk may ask the user about the identification information of the vehicle 10A and the identification information of the user and directly input the pieces of information into the POS terminal 700. Alternatively, the identification information of the vehicle 10A and the identification information of the user may be acquired such that a reader device provided in the POS terminal 700 reads a bar code, a QR Code (registered trademark), or the like shown on a membership card or displayed on the user terminal 200 and including the identification information of the user and the identification information of the vehicle 10A.

A hardware configuration of the store server 600 is generally the same as the center server 500, so the hardware configuration is not illustrated herein. The store server 600 includes a CPU, a memory, an external storage device, and a communication portion as the hardware configuration, and the CPU executes a computer program which is loaded in the memory in an executable way and executes a process as the store server 600.

The POS terminal 700 includes a CPU, a memory, an external storage device, a communication portion, and an input device such as a touch panel, a card reader, or a bar code reader as a hardware configuration, and the CPU executes a computer program which is loaded in the memory in an executable way and executes a process as the POS terminal 700.

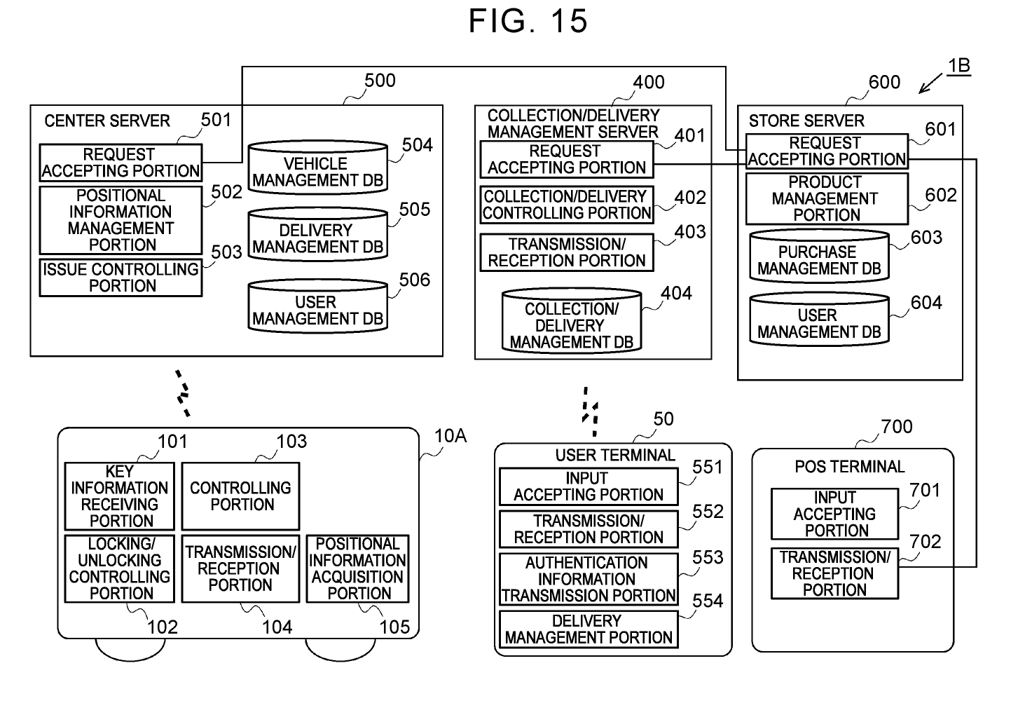

FIG. 15 is a view illustrating an example of functional configurations of the center server 500, the collection/delivery management server 400, the vehicle 10A, the user terminal 50 of the delivery user, the store server 600, and the POS terminal 700 in the purchased product delivery system 1B according to the second embodiment. The functional configurations of the center server 500, the collection/delivery management server 400, the vehicle 10A, and the user terminal 50 are similar to those in the first embodiment.

The request accepting portion 501 of the center server 500 and the request accepting portion 401 of the collection/delivery management server 400 receive, from the store server 600, a delivery request of a purchased product to the vehicle 10A in the second embodiment. Delivery management information of the purchased product, vehicle specification information of the vehicle 10A, and the like are also transmitted together with the delivery request. Upon receipt of the delivery request of the purchased product to the vehicle 10A, the request accepting portion 501 of the center server 500 and the request accepting portion 401 of the collection/delivery management server 400 register the delivery management information in the delivery management DB 505 and the collection/delivery management DB 404, respectively.

The store server 600 operates as each part exemplified in FIG. 15 by a computer program in the memory. That is, the store server 600 includes a request accepting portion 601, a product management portion 602, a purchase management DB 603, and a user management DB 604 as functional constituents.

The request accepting portion 601 executes an acceptance process of accepting, from the POS terminal 700, the delivery request of the purchased product to the vehicle 10A from the user of the vehicle 10A, for example. Information about the purchased product, identification information of the vehicle 10A as a delivery destination, and identification information of the user are also transmitted from the POS terminal 700 together with the delivery request, for example. The request accepting portion 601 is an example of a function of the “delivery management system.”

The acceptance process of accepting the delivery request is generally the same as the acceptance process of accepting the delivery request, which is a process performed by the request accepting portion 501 of the center server 500 according to the first embodiment. That is, as the acceptance process of the delivery request, the request accepting portion 601 determines whether or not the received delivery request is accepted, and when it is determined that the delivery request is acceptable, the request accepting portion 601 transmits the delivery request to the center server 500 and the collection/delivery management server 400. Delivery management information of the purchased product, vehicle specification information of the vehicle 10A, and the like are also transmitted together with the delivery request.

When the delivery request of the purchased product to the vehicle 10A is received by the request accepting portion 601, the product management portion 602 registers information about the purchased product in the purchase management DB 603.

The purchase management DB 603 and the user management DB 604 are formed in the external storage device of the store server 600, for example. A purchase history information table holding purchase history information about a purchased product in each store, received by the store server 600 from each POS terminal 700, is stored in the purchase management DB 603, for example. The purchase history information includes identification information of a purchase user, information about a purchased product, information on whether or not delivery to the vehicle 10A is performed, and the like, for example. Details of the purchase history information table will be described later.

The user management DB 604 includes, for example, information about a user who can receive the delivery service of a purchased product to the vehicle 10A. The user who can receive the delivery service of a purchased product to the vehicle 10A is, for example, a user who is registered as a member for the service provided by the store server 600.

Any of the functional constituents of the store server 600 or some of processes thereof may be executed by other computers connected to the network. Further, a series of processes executed by the store server 600 can be executed by hardware and can be also executed by software.

The POS terminal 700 operates as each part exemplified in FIG. 15 by a computer program in the memory. That is, the POS terminal 700 includes an input accepting portion 701 and a transmission/reception portion 702 as a functional configuration.

The input accepting portion 701 accepts a user operation from a user interface such as a touch panel, for example. In the second embodiment, the user operation input into the POS terminal 700 includes an input operation of a delivery request of a purchased product to the vehicle 10A, an input operation of information about the user of the vehicle 10A, and the like.

The transmission/reception portion 702 is an interface with the store server 600. For example, when an input operation of a delivery request of a purchased product to the vehicle 10A is received by the input accepting portion 701, the transmission/reception portion 702 transmits the delivery request to the store server 600.

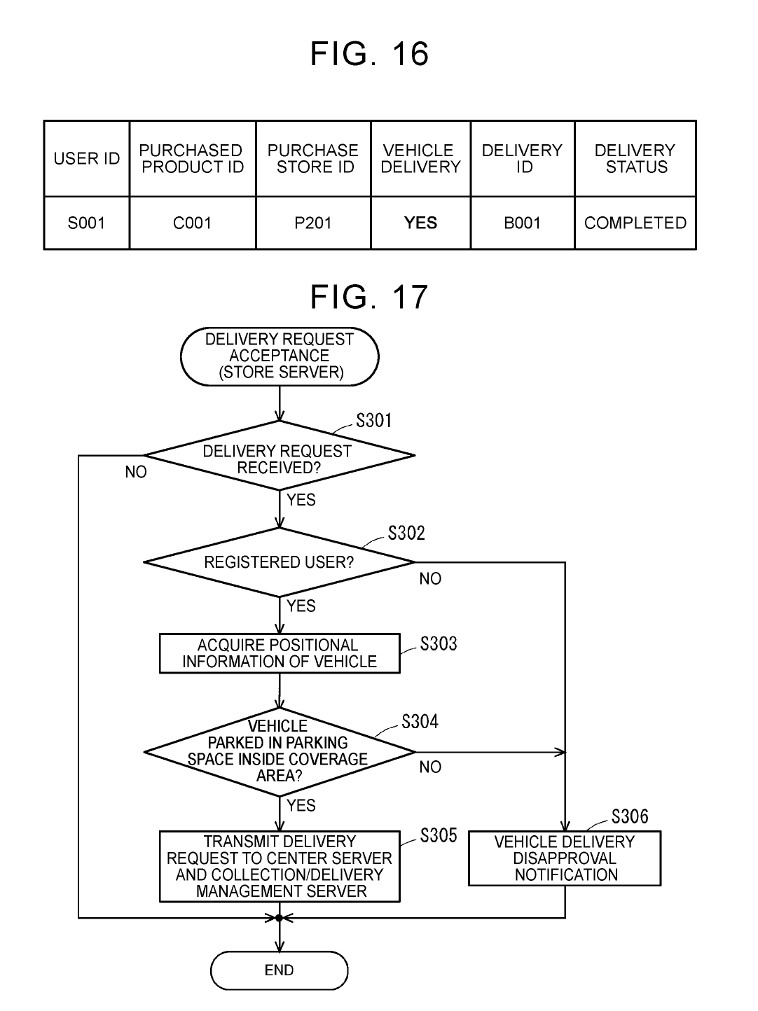

FIG. 16 illustrates an example of the purchase history information table. The purchase history information table is stored in the purchase management DB 603 of the store server 600. The purchase history information table has a user ID field, a purchased product ID field, a purchase store ID field, a vehicle delivery field, a delivery ID field, and a delivery status field.

Identification information of a user registered as a member for the service provided by the store server 600 is input in the user ID field. Identification information of a purchased product is input in the purchased product ID field. Identification information of a purchase store is input in the purchase store ID field.

Information indicating whether delivery of a corresponding purchased product to the vehicle 10A is requested or not is input into the vehicle delivery field. The information indicating whether delivery of a corresponding purchased product to the vehicle 10A is requested or not is a flag, for example. Identification information of a delivery request is input in the delivery ID field. The identification information of the delivery request is given by the request accepting portion 601 in the second embodiment, for example. Values of the user ID field, the purchased product ID field, the purchase store ID field, and the vehicle delivery field are acquired from information received together with the delivery request from the POS terminal 700, for example.

In the delivery status field, “UNCOMPLETED” or “COMPLETED” is input, for example. When a delivery completion notification is received from the user terminal 50 of the delivery user via the collection/delivery management server 400 in terms of a delivery request of identification information corresponding to a value of the delivery ID field, a value of the delivery status field is updated to “COMPLETED” by the product management portion 602, for example.

Note that a combination of values of the user ID field, the purchased product ID field, and the purchase store ID field in the purchase history information table is called delivery management information in the second embodiment and is information transmitted together with the delivery request transmitted from the store server 600 to the center server 500 and the collection/delivery management server 400.

FIG. 17 illustrates an example of a flowchart of a request acceptance process of the request accepting portion 601 of the store server 600 according to the second embodiment. The process illustrated in FIG. 17 is performed repeatedly at a predetermined cycle, for example.

In S301, the request accepting portion 601 determines whether a delivery request is received or not. When the delivery request is received (S301: YES), the process proceeds to S302. When the delivery request is not received (S301: NO), the process illustrated in FIG. 17 is ended.

In S302, the request accepting portion 601 determines whether or not the user of the user terminal 200 as a transmission source of the delivery request is the user who is registered as a member for the service provided by the store server 600. For example, since identification information of the user of the user terminal 200 as a request source is received together with the delivery request, the request accepting portion 601 performs the determination in S302 based on whether the received identification information of the user terminal 200 is registered in the user management DB 604 or not. The process of S302 is performed as simple user authentication.

When the user of the user terminal 200 as the transmission source of the delivery request is the user who is registered as a member for the service provided by the store server 600 (S302: YES), the process proceeds to S303. When the user of the user terminal 200 as the transmission source of the delivery request is not the user who is registered as a member for the service provided by the store server 600 (S302: NO), the process proceeds to S306. In S306, a vehicle delivery disapproval notification is transmitted to the user terminal 200 as the transmission source of the delivery request, for example. After that, the process illustrated in FIG. 17 is ended.

In S303, the request accepting portion 601 acquires positional information of the vehicle 10A. The positional information of the vehicle 10A may be acquired from the center server 500 such that an acquisition request of positional information of the vehicle 10A is transmitted to the center server 500, for example.

In S304, the request accepting portion 601 determines whether or not the vehicle 10A is parked in the parking space in the site (“INSIDE COVERAGE AREA” in the figure) of the shopping center A. For example, the store server 600 holds, in advance in the memory, a map of the shopping center A, positional information of the parking space in the shopping center A, and the like. The request accepting portion 601 performs the determination in S304 based on the positional information of the vehicle 10A and the positional information of the parking space in the shopping center A.

When the vehicle 10A is parked in the parking space in the site (“INSIDE COVERAGE AREA” in the figure) of the shopping center A (S304: YES), the process proceeds to S305. When the vehicle 10A is not parked in the parking space in the site (“INSIDE COVERAGE AREA” in the figure) of the shopping center A (S304: NO), the process proceeds to S307. In S307, the request accepting portion 601 transmits a vehicle delivery disapproval notification to the user terminal 200, for example. After that, the process illustrated in FIG. 17 is ended. The processes of S303 and S304 are a process of checking that the vehicle 10A is present in the coverage area of the delivery service of a purchased product to a vehicle.

In S305, the request accepting portion 601 transmits the delivery request to the center server 500 and the collection/delivery management server 400. Delivery management information and identification information of the vehicle 10A are also transmitted together with the delivery request. Note that, in the second embodiment, when the collection/delivery management server 400 receives the delivery request from the store server 600, the collection/delivery management server 400 refers to the center server 500 for vehicle specification information corresponding to the identification information of the vehicle 10A, received together with the delivery request, and acquires the vehicle specification information. After that, the process illustrated in FIG. 17 is ended.

Note that the request acceptance process illustrated in FIG. 17 is an example, and the request acceptance process by the request accepting portion 601 of the store server 600 is not limited to this. The process of S302 and the processes from S303 to S304 are optional and may be omitted depending on the embodiment.

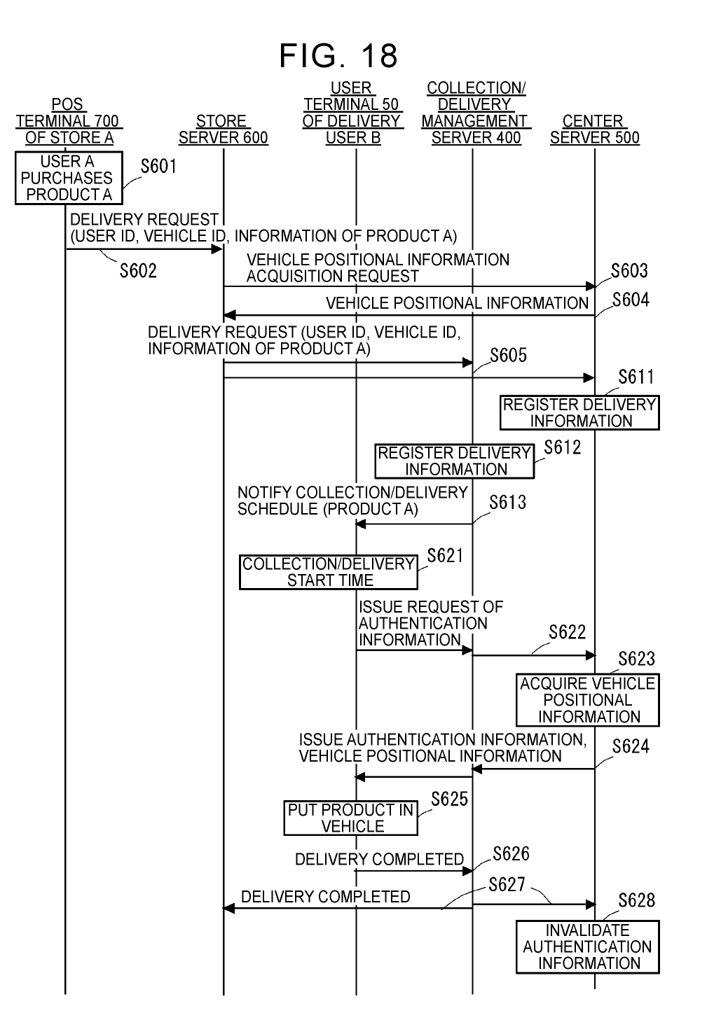

FIG. 18 illustrates an example of a processing sequence in a concrete example of the second embodiment. The concrete example of the second embodiment deals with an example in which the user A purchases the product A at the store A in the shopping center A and requests delivery of the product A to the vehicle 10A. It is premised that the user A is registered as a member for the service provided by the store server 600, and identification information of the user A is registered in the user management DB 604 of the store server 600. Further, it is premised that the vehicle 10A of the user A is parked in the parking space of the shopping center A.

In S601, the user A purchases the product A at the store A in the time zone #1, and a salesclerk of the store A performs, on a POS terminal 700A provided in the store A, a user operation for a delivery request of delivering the product A to the vehicle 10A. In S602, the POS terminal 700A transmits, to the store server 600, the delivery request of delivering the product A to the vehicle 10A, and the store server 600 receives the delivery request (FIG. 17, S301: YES). The identification information of the user A, identification information of the vehicle 10A, and information about the product A are also transmitted together with the delivery request.

In S603, the store server 600 transmits an acquisition request of positional information of the vehicle 10A to the center server 500. In S604, the center server 500 acquires the positional information of the vehicle 10A, for example, by reading the positional information from the vehicle management DB 504 or by referring to the vehicle 10A for the positional information, and the center server 500 transmits the positional information to the store server 600 (FIG. 17, S303).

In S605, the store server 600 determines that the vehicle 10A is parked in the parking space of the shopping center A (FIG. 17, S304: YES), and then, the store server 600 accepts the delivery request from the user terminal 200 and transmits the delivery request to the center server 500 and the collection/delivery management server 400 (FIG. 17, S305). Delivery request information corresponding to the delivery request and vehicle specification information of the vehicle 10A are also transmitted together with the delivery request. Further, the store server 600 registers the information about the product A, received together with the delivery request, in the purchase management DB 603.

In S611, the center server 500 receives the delivery request of delivering the product A to the vehicle 10A from the store server 600 and registers the delivery request information in the delivery management DB 504. In S612, the collection/delivery management server 400 receives the delivery request of delivering the product A to the vehicle 10A from the store server 600 and registers the delivery request information in the collection/delivery management DB 404.

In S613, the collection/delivery management server 400 sets a collection/delivery schedule for the delivery request of delivering the product A to the vehicle 10A to the time zone #2 subsequent to the time zone #1, determines the delivery user B as a delivery user, and transmits the collection/delivery schedule to the user terminal 50 of the delivery user B. The delivery management information of the delivery request and the vehicle specification information of the vehicle 10A are transmitted together with the collection/delivery schedule.

In S621, a start time of the time zone #2 as the collection/delivery schedule of the product A comes. In S622, the user terminal 50 of the delivery user B transmits an issue request of authentication information of the vehicle 10A as the delivery destination of the product A to the center server 500 via the collection/delivery management server 400, and the center server 500 receives the issue request of authentication information (FIG. 12, S201). Identification information of the delivery request is also transmitted together with the issue request of authentication information.

In S623, since a target delivery request corresponding to the issue request of authentication information is registered in the delivery management DB 505 (FIG. 12, S202: YES), the center server 500 acquires positional information of the vehicle 10A (FIG. 12, S203). In S624, the center server 500 determines that the vehicle 10A is parked in the parking space in the site of the shopping center A (FIG. 12, S204: YES), and the center server 500 transmits the authentication information and the positional information of the vehicle 10A to the user terminal 50 of the delivery user B (FIG. 12, S205).

In S625, the delivery user B collects the product A at the store A and moves to a position indicated by the positional information of the vehicle 10A. Then, the delivery user B unlocks the door of the vehicle 10A by transmitting the authentication information of the vehicle 10A from the user terminal 50 and puts the product A in the vehicle 10A. Further, the delivery user B locks the door of the vehicle 10A by transmitting the authentication information of the vehicle 10A from the user terminal 50. Note that a collection method of a purchased product to be delivered is not limited to the above method in which a purchased product is collected by a delivery user and may be a method in which a salesclerk of each store brings a purchased product to a predetermined collection place.

In S626, the delivery user B inputs, into the user terminal 50, delivery completion for the delivery request of delivering the product A, and the user terminal 50 transmits a delivery completion notification for the delivery request of delivering the product A to the collection/delivery management server 400. In S627, the collection/delivery management server 400 transmits, to the center server 500 and the store server 600, the delivery completion notification for the delivery request of delivering the product A, the delivery completion notification being received from the user terminal 50.

In S628, the center server 500 receives the delivery completion notification for the delivery request of delivering the product A (FIG. 12, S206: YES) and performs an invalidation process on the authentication information of the vehicle 10A that is issued to the user terminal 50 (FIG. 12, S207).

In the second embodiment, the store server 600 that manages each store in the shopping center A receives, from the POS terminal 700, a delivery request of a purchased product to the vehicle 10A. Hereby, a liaison between the store server 600 and the center server 500 is formed. Accordingly, in a case where the store server 600 and the center server 500 are managed by different organizations, a new commercial transaction occurs.

In the first embodiment, a delivery request is transmitted from the user terminal 200 of the vehicle 10A, and the center server 500 accepts the delivery request. Instead of this, a delivery request may be transmitted from the POS terminal 700 via the store server 600, the center server 500 may accept the delivery request, and the center server 500 may process the delivery request as described in the first embodiment.

Further, in the second embodiment, a delivery request is transmitted from the POS terminal 700, and the store server 600 receives the delivery request. Instead of this, a delivery request may be transmitted from the user terminal 200 of the vehicle 10A, the store server 600 may accept the delivery request, and the store server 600 may process the delivery request as described in the second embodiment.

In the first embodiment and the second embodiment, the vehicle 10A includes the data communication device 150, and positional information of the vehicle 10A, acquired by position acquisition means (the GPS receiving portion 156) provided in the data communication device 150, is transmitted to the center server 500 and is used as the positional information of the vehicle 10A. However, the vehicle 10A may not include the data communication device 150. In a case where the vehicle 10A does not include the data communication device 150, the positional information of the vehicle 10A may be acquired as an identification number of a parking position of the vehicle 10A, the identification number being input into the user terminal 200 by the user of the vehicle 10A. Alternatively, in a case where the vehicle 10A does not include the data communication device 150, the positional information of the vehicle 10A may be acquired from a car navigation device provided in the vehicle 10A via a predetermined server that communicates with the car navigation device.

Further, the positional information of the vehicle 10A to be transmitted to the center server 500 from the vehicle 10A and the positional information of the vehicle 10A to be transmitted to the user terminal 50 of the delivery user from the collection/delivery management server 400 may be the same type or may be different types. Exemplary types of the positional information of the vehicle 10A are latitude and longitude, an address, a position on a map, identification information of a parking position of the vehicle 10A in the shopping center A, and the like. In a case where the positional information of the vehicle 10A to be transmitted to the center server 500 from the vehicle 10A and the positional information of the vehicle 10A to be transmitted to the user terminal 50 of the delivery user from the collection/delivery management server 400 are different types, the positional information may be converted into positional information of a type that is more easily recognizable by the delivery user in either or both of the center server 500 and the collection/delivery management server 400, for example.

Further, in the first embodiment and the second embodiment, identification information of the vehicle 10A to become a delivery destination is also transmitted together with a delivery request from the user terminal 200 or the POS terminal 700 as a delivery request source. However, the first embodiment and the second embodiment are not limited to this, and in a case where the vehicle 10A to become a delivery destination is limited to one in advance and is registered in the center server 500, the identification information of the vehicle 10A to become a delivery destination may not be transmitted together with the delivery request.

Further, in the first embodiment and the second embodiment, a collection/delivery schedule of a purchased product to the vehicle 10A is determined in a time zone subsequent to a time zone during which its delivery request is accepted. However, a determination method of a collection/delivery schedule of a purchased product to the vehicle 10A is not limited to this. For example, a collection/delivery schedule may be designated by the user of the vehicle 10A, or delivery of a purchased product to the vehicle 10A may be started upon receipt of a delivery start instruction transmitted from the user of the vehicle 10A via the user terminal 200. Alternatively, a time zone of delivery may be determined in accordance with a type of a purchased product. For example, accessories may be delivered in a time zone subsequent to a time zone during which a delivery request is accepted, and raw food may be delivered after an instruction from the user of the vehicle 10A is received.

A program to cause a computer and other machines or devices (hereinafter referred to as the computer or the like) to implement the process of the center server 500 can be stored in a recording medium readable by the computer or the like. By causing the computer or the like to read and implement the program stored in the recording medium, the computer or the like functions as the center server 500.

Here, the recording medium readable by the computer or the like is a non-transitory recording medium in which information such as data or a program is stored electrically, magnetically, optically, mechanically, or chemically and from which the information can be read by the computer or the like. In such a recording medium, a recording medium that is removable from the computer or the like is, for example, a flexible disk, a magneto-optical disk, a CD-ROM, a CD-R/W, a DVD, a Blu-ray disk, a DAT, an 8-mm tape, a memory card such as a flash memory, and the like. Further, a recording medium fixed to the computer or the like includes a hard disk, a read only memory (ROM), and the like. Further, a solid state drive (SSD) is also usable as the recording medium removable from the computer or the like or the recording medium fixed to the computer or the like.

What is claimed is:

1. A delivery management system comprising a server configured to:
receive a delivery request of a purchased product which is purchased at a store in a delivery coverage area including a plurality of stores, information about the purchased product, and information about a purchase user who purchases the purchased product;
store key information of a vehicle associated with the purchase user, the vehicle being configured to be locked and unlocked upon receipt of the key information transmitted from a terminal;
acquire positional information of the vehicle; and
transmit, to a terminal of a delivery user, the delivery request of the purchased product, the information about the purchased product, the key information of the vehicle, and the positional information of the vehicle, wherein the delivery request of the purchased product is a request of delivering the purchased product to the vehicle.

2. The delivery management system according to claim 1, wherein the server is configured to:
determine whether or not the vehicle is parked in a parking space inside the delivery coverage area; and
transmit the key information of the vehicle and the positional information of the vehicle to the terminal of the delivery user, when the vehicle is parked in the parking space inside the delivery coverage area.

3. The delivery management system according to claim 1, wherein the server is configured to receive the delivery request of the purchased product, the information about the purchased product, and the information about the purchase user that are transmitted from a terminal of the purchase user.

4. The delivery management system according to claim 1, further comprising a plurality of store terminals each of which is provided in each of the plurality of the stores respectively, wherein each of the plurality of the store terminals is configured to transmit the delivery request of the purchased product, the information about the purchased product, and the information about the purchase user.

5. A key information management device comprising a processor configured to:
receive a delivery request of a purchased product which is purchased at a store in a delivery coverage area including a plurality of stores, and information about a purchase user who purchases the purchased product;
store key information of a vehicle associated with the purchase user, the vehicle being configured to be locked and unlocked upon receipt of the key information transmitted from a terminal;
acquire positional information of the vehicle; and
transmit the key information of the vehicle and the positional information of the vehicle to a terminal of a delivery user who receives the delivery request of the purchased product, wherein the delivery request of the purchased product is a request of delivering the purchased product to the vehicle.

6. The key information management device according to claim 5, wherein the processor is configured to:
determine whether or not the vehicle is parked in a parking space inside the delivery coverage area; and
transmit the key information of the vehicle and the positional information of the vehicle to the terminal of the delivery user, when the vehicle is parked in the parking space inside the delivery coverage area.

7. A delivery management device comprising a processor configured to:
receive a delivery request of a purchased product which is purchased at a store in a delivery coverage area including a plurality of stores, information about the purchased product, and information about a purchase user who purchases the purchased product;
receive key information of a vehicle associated with the purchase user and positional information of the vehicle, the vehicle being configured to be locked and unlocked upon receipt of the key information transmitted from a terminal; and
transmit, to a terminal of a delivery user, the delivery request of the purchased product, the information about the purchased product, the key information of the vehicle, and the positional information of the vehicle, wherein the delivery request of the purchased product is a request of delivering the purchased product to the vehicle.

8. A delivery management method comprising:
causing a computer to receive a delivery request of a purchased product which is purchased at a store in a delivery coverage area including a plurality of stores, information about the purchased product, and information about a purchase user who purchases the purchased product;
causing the computer to store key information of a vehicle associated with the purchase user, the vehicle being configured to be locked and unlocked upon receipt of the key information transmitted from a terminal;
causing the computer to acquire positional information of the vehicle; and
causing the computer to transmit, to a terminal of a delivery user, the delivery request of the purchased product, the information about the purchased product, the key information of the vehicle, and the positional information of the vehicle, wherein the delivery request of the purchased product is a request of delivering the purchased product to the vehicle.

9. A non-transitory recording medium having a program stored therein, the program causing a computer to perform a control process, the control process comprising:
receiving a delivery request of a purchased product which is purchased at a store in a delivery coverage area including a plurality of stores, information about the purchased product, and information about a purchase user who purchases the purchased product;
storing key information of a vehicle associated with the purchase user, the vehicle being configured to be locked and unlocked upon receipt of the key information transmitted from a terminal;
acquiring positional information of the vehicle; and
transmitting, to a terminal of a delivery user, the delivery request of the purchased product, the information about the purchased product, the key information of the vehicle, and the positional information of the vehicle, wherein the delivery request of the purchased product is a request of delivering the purchased product to the vehicle.
